(19) United States
(12) Patent Application Publication
(10) Pub. No.: US 2025/0134147 A1
(43) Pub. Date: May 1, 2025

(54) METHODS AND COMPOSITIONS FOR IMPROVED SUGAR-LIKE TASTE

(71) Applicant: ALMENDRA (THAILAND) LTD., Bangkok (TH)

(72) Inventor: Inder Singh MAHAN SINGH, Bangkok (TH)

(21) Appl. No.: 18/725,995

(22) PCT Filed: Dec. 1, 2022
(86) PCT No.: PCT/IB2022/061663

§ 371 Date: Jul. 1, 2024

Related U.S. Application Data
(60) Provisional application No. 63/284,898, filed on Dec. 1, 2021.

(51) Int. Cl. A23L 27/30; A23L 2/56; A23L 2/60

(52) U.S. Cl. CPC A23L 27/36; A23L 2/56; A23L 2/60

(57) ABSTRACT

The disclosure relates to sweetener compositions, methods of making same, and products comprising same. In an aspect, the sweetener composition can include one or more steviol glycosides. For example, the steviol glycoside can include rebaudioside A, rebaudioside B, rebaudioside C, rebaudioside D, rebaudioside F, dulcoside A, rubusoside, and/or steviobioside. In various aspects, the disclosed compositions comprise a sweetening agent. In further aspects, the disclosed beverage compositions comprise a sweetener composition. In further aspects, the disclosed beverage composition comprising a sweetener composition as described herein is a cola or lemon-lime flavored beverage.

### CROSS-REFERENCE TO RELATED APPLICATIONS

This application claims the benefit of and priority to U.S. Non-Provisional application Ser. No. 63/284,898, having the title “METHODS AND COMPOSITIONS FOR Improved SUGAR-LIKE TASTE”, filed on Dec. 1, 2021, the disclosure which is incorporated herein by reference in their entireties.

### BACKGROUND

Natural sugars, such as sucrose, fructose and glucose, are utilized in the food and beverage industries to provide a pleasant taste to foods and beverages. In addition, natural sugars are commonly used in pharmaceuticals, nutraceuticals, and oral hygienic/cosmetic products to similarly impart a pleasant taste. Sucrose, in particular, imparts a taste that is highly preferred by many consumers. Although sucrose provides superior sweetness characteristics, it is caloric. High-potency (“HP”) sweeteners have been introduced to address consumer demand for products having a pleasant taste, while at the same time meet increasing demand for healthier, reduced calorie products. Moreover, the demand for healthier, reduced calorie products is being driven by public policy and regulatory mandates.

However, HP sweeteners (also referred to herein as sweeteners or sweetener compositions, for example) differ significantly from natural caloric sugars in ways that frustrate consumers and limit market penetration of products containing many HP sweeteners. On a taste basis, HP sweeteners exhibit a temporal profile, maximal response, flavor profile, mouthfeel, and/or adaptation behavior that differs from sugar. Commonly, HP sweeteners exhibit delayed sweetness onset, lingering sweet aftertaste, bitter taste, metallic taste, astringent taste, cooling taste and/or licorice-like taste. HP sweeteners may be synthetic chemicals, natural substances, physically or chemically modified natural substances, and/or reaction products obtained from synthetic and/or natural substances. The desire for natural HP sweeteners with favorable taste characteristics remains high.

One class of HP sweeteners are the steviol glycosides. However, utilization has been limited to date by certain undesirable taste properties, including licorice taste, bitterness, astringency, sweet aftertaste, bitter aftertaste, and licorice aftertaste. These undesirable taste properties tend to become more prominent with increased concentration. For example, these undesirable taste attributes are particularly prominent in carbonated beverages, where full replacement of sugar may involve concentrations of steviol glycosides that exceed 500 mg/L.

Importantly, although there exist certain taste modulators that have addressed some or many of the undesirable taste properties of HP sweeteners, the use of taste modulators has added significant cost to the use of HP sweeteners. For example, although a blend consisting of a steviol glycoside, rebaudioside A, with meso-erythritol can ameliorate the undesirable taste properties of rebaudioside A, it also results in a cost increase of about 2- to 4-fold for the good-tasting blends compared to rebaudioside A alone. The cost increase is even more significant when compared to the costs associated with sweeteners such as aspartame- or aspartame/acesulfame-sweetened products.

Despite advances in compositions and methods for sweetening foods, beverages, and other products, there is a scarcity of HP sweeteners that have both the taste properties of sucrose, fructose and glucose and suitably low cost for widespread use. These needs and other needs are satisfied by the present disclosure.

### SUMMARY

In accordance with the purpose(s) of the present disclosure, as embodied and broadly described herein, the disclosure, in one aspect, relates to sweetener and/or savory compositions, methods of making same, and products comprising same. In various aspects, the disclosed sweetener compositions comprise a sweetening composition that allows for the reduction of sugar in resulting food and beverage compositions with satisfactory taste profiles.

The following are illustrative examples of various embodiments of the present disclosure.

The present disclosure provides for a composition comprising: an effective amount of total steviol glycosides; an effective amount of rebaudioside A; and an effective amount of rebaudioside C.

The composition described above and herein further comprises an effective amount of steviolbioside.

The composition described above and herein further comprises an effective amount of rebaudioside D.

The composition described above and herein further comprising an effective amount of stevioside.

The composition described above and herein further comprises an effective amount of rebaudioside F.

The composition of described above and herein further comprises an effective amount of dulcoside A.

The composition described above and herein further comprises an effective amount of rubusoside.

The composition described above and herein further comprises an effective amount of rebaudioside B.

The present disclosure provides for a composition comprising: an effective amount of steviolbioside; and an effective amount of rebaudioside A.

The composition described above and herein further comprises an effective amount of rebaudioside C.

The composition described above and herein further comprises an effective amount of total steviol glycosides.

The composition described above and herein further comprises an effective amount of rebaudioside D.

The composition described above and herein further comprises an effective amount of stevioside.

The composition described above and herein further comprises an effective amount of rebaudioside F.

The composition described above and herein further comprises an effective amount of dulcoside A.

The composition described above and herein further comprises an effective amount of rubusoside.

The composition described above and herein further comprises an effective amount of rebaudioside B.

The present disclosure provides for a composition comprising: an effective amount of steviolbioside; and an effective amount of rebaudioside C.

The composition described above and herein further comprises an effective amount of rebaudioside A.

The composition described above and herein further comprises an effective amount of total steviol glycosides.

The composition described above and herein further comprises an effective amount of rebaudioside D.

The composition described above and herein further comprises an effective amount of stevioside.

The composition described above and herein further comprises an effective amount of rebaudioside F.

The composition described above and herein further comprises an effective amount of dulcoside A.

The composition described above and herein further comprises an effective amount of rubusoside.

The composition described above and herein further comprises an effective amount of rebaudioside B.

A composition comprising: an effective amount of steviolbioside; an effective amount of rebaudioside A; and an effective amount of rebaudioside C.

The composition described above and herein further comprises an effective amount of total steviol glycosides.

The composition described above and herein further comprises an effective amount of rebaudioside D.

The composition described above and herein further comprises an effective amount of stevioside.

The composition described above and herein further comprises an effective amount of rebaudioside F.

The composition described above and herein further comprises an effective amount of dulcoside A.

The composition described above and herein further comprises an effective amount of rubusoside.

The composition described above and herein further comprises an effective amount of rebaudioside B.

A composition comprising: an effective amount of steviolbioside; and an effective amount of total steviol glycosides.

The composition described above and herein further comprises an effective amount of rebaudioside A.

The composition described above and herein further comprises an effective amount of rebaudioside D.

The composition described above and herein further comprises an effective amount of stevioside.

The composition described above and herein further comprises an effective amount of rebaudioside F.

The composition described above and herein further comprises an effective amount of dulcoside A.

The composition described above and herein further comprises an effective amount of rubusoside.

The composition described above and herein further comprises an effective amount of rebaudioside B.

The composition described above and herein further comprises an effective amount of rebaudioside C.

A composition comprising: an effective amount of steviolbioside.

The composition described above and herein further comprises an effective amount of total steviol glycosides

The composition described above and herein further comprises an effective amount of rebaudioside A.

The composition described above and herein further comprises an effective amount of rebaudioside D.

The composition described above and herein further comprises an effective amount of stevioside.

The composition described above and herein further comprises an effective amount of rebaudioside F.

The composition described above and herein further comprises an effective amount of dulcoside A.

The composition described above and herein further comprises an effective amount of rubusoside.

The composition described above and herein further comprises an effective amount of rebaudioside B.

The composition described above and herein further comprises an effective amount of rebaudioside C.

The present disclosure provides a composition comprising: total steviol glycosides in an amount of about 76% to about 82% w/w; rebaudioside A in an amount of about 35% to about 44% w/w; and rebaudioside C in an amount of about 6% to about 10% w/w.

The composition described above and herein further comprises steviolbioside in an amount of about 3% to about 3.6% w/w.

The composition described above and herein further comprises rebaudioside D in an amount of about 1% w/w to about 2% w/w.

The composition described above and herein further comprises stevioside in an amount of about 16% to about 19% w/w.

The composition described above and herein further comprises rebaudioside F in an amount of about 0.75% to about 1.5% w/w.

The composition described above and herein further comprises dulcoside in an amount of about 0.2% to about 0.5% w/w.

The composition described above and herein further comprises rubusoside in an amount of about 0.1% to about 1% w/w.

The composition described above and herein further comprises rebaudioside B in an amount of about 6.5% to about 7% w/w.

A composition comprising: steviolbioside in an amount of about 3% to about 3.6% w/w; and rebaudioside A in an amount of about 35% to about 44% w/w.

The composition described above and herein, further comprises rebaudioside C in an amount of about 6% to about 10% w/w.

The composition described above and herein, further comprises total steviol glycosides in an amount of about 76% to about 82% w/w.

The composition described above and herein, further comprises rebaudioside D in an amount of about 1% w/w to about 2% w/w.

The composition described above and herein further comprises stevioside in an amount of about 16% to about 19% w/w.

The composition described above and herein further comprises rebaudioside F in an amount of about 0.75% to about 1.5% w/w.

The composition described above and herein further comprises dulcoside in an amount of about 0.2% to about 0.5% w/w.

The composition described above and herein further comprises rubusoside in an amount of about 0.1% to about 1% w/w.

The composition described above and herein further comprises rebaudioside B in an amount of about 6.5% to about 7% w/w.

A composition comprising steviolbioside in an amount of about 3% to about 3.6% w/w; and rebaudioside C in an amount of about 6% to about 10% w/w.

The composition described above and herein further comprises rebaudioside A in an amount of about 35% to about 44% w/w.

The composition described above and herein further comprises total steviol glycosides in an amount of about 76% to about 82% w/w.

The composition described above and herein further comprises rebaudioside D in an amount of about 1% w/w to about 2% w/w.

The composition described above and herein further comprises stevioside in an amount of about 16% to about 19% w/w.

The composition described above and herein further comprises rebaudioside F in an amount of about 0.75% to about 1.5% w/w.

The composition described above and herein further comprises dulcoside in an amount of about 0.2% to about 0.5% w/w.

The composition described above and herein further comprises rubusoside in an amount of about 0.1% to about 1% w/w.

The composition described above and herein further comprises rebaudioside B in an amount of about 6.5% to about 7% w/w.

A composition comprising: steviolbioside in an amount of about 3% to about 3.6% w/w; rebaudioside A in an amount of about 35% to about 44% w/w; and rebaudioside C in an amount of about 6% to about 10% w/w.

The composition described above and herein further comprises total steviol glycosides in an amount of about 76% to about 82% w/w.

The composition described above and herein further comprises rebaudioside D in an amount of about 1% w/w to about 2% w/w.

The composition described above and herein further comprises stevioside in an amount of about 16% to about 19% w/w.

The composition described above and herein further comprises rebaudioside F in an amount of about 0.75% to about 1.5% w/w.

The composition described above and herein further comprises dulcoside in an amount of about 0.2% to about 0.5% w/w.

The composition of described above and herein further comprises rubusoside in an amount of about 0.1% to about 1% w/w.

The composition described above and herein further comprises rebaudioside B in an amount of about 6.5% to about 7% w/w.

The present disclosure provides for a composition comprising: steviolbioside in an amount of about 3% to about 3.6% w/w; and total steviol glycosides in an amount of about 76% to about 82% w/w.

The composition described above and herein further comprises rebaudioside A in an amount of about 35% to about 44% w/w.

The composition described above and herein further comprises rebaudioside D in an amount of about 10% w/w to about 2% w/w.

The composition described above and herein further comprises stevioside in an amount of about 16% to about 19% w/w.

The composition described above and herein further comprises rebaudioside F in an amount of about 0.75% to about 1.5% w/w.

The composition described above and herein further comprises dulcoside in an amount of about 0.2% to about 0.5% w/w.

The composition described above and herein further comprises rubusoside in an amount of about 0.1% to about 1% w/w.

The composition described above and herein further comprises rebaudioside B in an amount of about 6.5% to about 7% w/w.

The composition described above and herein further comprises rebaudioside C in an amount of about 6% to about 10% w/w.

The present disclosure provides for a composition comprising: steviolbioside in an amount of about 3% to about 3.6% w/w.

The composition described above and herein further comprises total steviol glycosides in an amount of about 76% to about 82% w/w.

The composition described above and herein further comprises rebaudioside A in an amount of about 35% to about 44% w/w.

The composition described above and herein further comprises rebaudioside D in an amount of about 1% w/w to about 2% w/w.

The composition described above and herein further comprises stevioside in an amount of about 16% to about 19% w/w.

The composition described above and herein further comprises rebaudioside F in an amount of about 0.75% to about 1.5% w/w.

The composition described above and herein further comprises dulcoside in an amount of about 0.2% to about 0.5% w/w.

The composition described above and herein further comprises rubusoside in an amount of about 0.1% to about 1% w/w.

The composition described above and herein, further comprises rebaudioside B in an amount of about 6.5% to about 7% w/w.

The composition described above and herein further comprises rebaudioside C in an amount of about 6% to about 10% w/w.

The composition described above and herein further comprises trace amounts of glucose.

The composition described above and herein wherein the composition does not contain glucose.

The present disclosure provides for a food or beverage composition comprising a composition of any one of the those described above and herein.

The present disclosure provides for a food or beverage composition comprising an effective amount of any one of composition described above and herein.

The present disclosure provides for a beverage composition comprising an effective amount of any one of the compositions described above and herein.

The present disclosure provides for a beverage composition comprising a composition of any one of one of the compositions described above and herein.

The present disclosure provides for a beverage composition comprising a sweetener, the sweetener comprising: total steviol glycosides in an amount of about 76% to about 82% w/w; rebaudioside D in an amount of about 1% w/w to about 2% w/w; rebaudioside A in an amount of about 35% to about 44% w/w; stevioside in an amount of about 16% to about 19% w/w; rebaudioside F in an amount of about 0.75% to about 1.5% w/w; rebaudioside C in an amount of about 6% to about 10% w/w; dulcoside A in an amount of about 0.2% to about 0.5% w/w; rubusoside in an amount of about 0.1% to about 1% w/w; rebaudioside B in an amount of about 6.5% to about 7% w/w; and steviolbioside in an amount of about 3% to about 3.6% w/w.

The beverage composition described above and herein wherein the sweetener composition further comprises trace amounts of glucose.

The beverage composition described above and herein wherein the sweetener composition does not contain glucose.

The beverage composition described above and herein wherein the beverage composition further comprises a cola-flavored or lemon-lime flavored beverage.

The beverage composition described above and herein wherein the beverage composition further comprises a carbonated cola-flavored or carbonated lemon-lime flavored beverage.

The beverage composition described above and herein wherein the beverage composition further comprises a Coca-Cola® beverage.

The beverage composition described above and herein wherein the beverage composition further comprises a Sprite® beverage.

The present disclosure provides for a beverage composition comprising a sweetener, the sweetener comprising: total steviol glycosides in an amount of about 76% w/w; rebaudioside D in an amount of about 1.5% w/w; rebaudioside A in an amount of about 36% w/w stevioside in an amount of about 17% w/w; rebaudioside F in an amount of about 1.4% w/w; rebaudioside C in an amount of about 10% to about 10% w/w; dulcoside A in an amount of about 0.2% w/w; rubusoside in an amount of about 1% w/w; rebaudioside B in an amount of about 7% w/w; and steviolbioside in an amount of about 3% w/w.

The beverage composition described above and herein wherein the sweetener composition further comprises trace amounts of glucose.

The beverage composition described above and herein wherein the sweetener composition does not contain glucose.

The beverage composition described above and herein wherein the beverage composition further comprises a cola-flavored or lemon-lime flavored beverage.

The beverage composition described above and herein wherein the beverage composition further comprises a carbonated cola-flavored or carbonated lemon-lime flavored beverage.

The beverage composition described above and herein wherein the beverage composition further comprises a Coca-Cola® beverage.

The beverage composition described above and herein wherein the beverage composition further comprises a Sprite® beverage.

The present disclosure provides for a beverage composition comprising a sweetener, the sweetener comprising: total steviol glycosides in an amount of about 82% w/w; rebaudioside D in an amount of about 2% w/w; rebaudioside A in an amount of about 44% w/w; stevioside in an amount of about 19% w/w; rebaudioside F in an amount of about 0.8% w/w; rebaudioside C in an amount of about 6.5% w/w; dulcoside A in an amount of about 0.5% w/w; rubusoside in an amount of about 0.1% w/w; rebaudioside B in an amount of about 6.5% w/w; and steviolbioside in an amount of about 3.5% w/w.

The beverage composition described above and herein wherein the sweetener composition further comprises trace amounts of glucose.

The beverage composition described above and herein wherein the sweetener composition does not contain glucose.

The beverage composition described above and herein wherein the beverage composition further comprises a cola-flavored or lemon-lime flavored beverage.

The beverage composition described above and herein wherein the beverage composition further comprises a carbonated cola-flavored or carbonated lemon-lime flavored beverage.

The beverage composition described above and herein wherein the beverage composition further comprises a Coca-Cola® beverage.

The beverage composition described above and herein wherein the beverage composition further comprises a Sprite® beverage.

The present disclosure provides for a sweetener composition as described above and herein, further comprising sucralose.

The present disclosure provides for a sweetener composition as described above and herein, further comprising erythritol.

The present disclosure provides for a beverage composition as described above and herein, further comprising sucralose.

The present disclosure provides for a beverage composition as described above and herein, further comprising erythritol.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows chemical structures for representative stevia-derived compounds as indicated (Rebaudioside A, Rebaudioside B, Rebaudioside C, Rebaudioside D, and Rebaudioside E).

FIG. 2 shows chemical structures for representative stevia-derived compounds as indicated (Rebaudioside F, Rebaudioside M, Rebaudioside N, Steviol, and Steviolmonoside).

FIG. 3 shows chemical structures for representative stevia-derived compounds as indicated (Stevioside, Dulcoside A, Steviolbioside, and Rubusoside).

FIG. 4 is a plot showing perceivable sensory attributes when replacing sugar (30%) with aspects of the present disclosure.

FIG. 5 is a plot showing perceivable sensory attributes when replacing sugar (50%) with aspects of the present disclosure

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Additionally, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “HP sweetener,” “a sweetening agent,” or “a taste modulator,” including, but not limited to, two or more such HP sweeteners, sweetening agents, or taste modulators, including combinations of sweetening agents, and taste modulators, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, “stevia sweetener,” “stevia-derived sweetener,” and “Stevia rebaudiana-derived sweetener” can be used interchangeably. It is understood that a stevia sweetener can refer to an extract, concentrate, juice, or other preparation obtained from leaves and/or other plant structures (e.g., fruits, seeds, stems or fleshy plant parts) of a plant in the genus Stevia, in some cases from the Stevia rebaudiana plant; or a mixture of one or more purified or partially purified component or compound from a plant in the genus Stevia, in some cases from the Stevia rebaudiana plant, such as steviol glycosides, stevioside, rebaudioside A, rebaudioside B, rebaudioside C, rebaudioside F, rebaudioside F, dulcoside A, steviolbioside, rubusoside, as well as other steviol glycosides found in a plant in the genus Stevia, in some cases from the Stevia rebaudiana plant, and mixtures thereof; glucosylated steviol glucosides; and combinations, mixtures, and kits comprising such.

As used herein, the term “steviol glycoside(s)” refers to glycosides of steviol, including, but not limited to, naturally occurring steviol glycosides, e.g. Rebaudioside A, Rebaudioside B, Rebaudioside C, Rebaudioside D, Rebaudioside E, Rebaudioside F, Rebaudioside O, Rebaudioside H, Rebaudioside I, Rebaudioside J, Rebaudioside K, Rebaudioside L, Rebaudioside M (also referred to as Rebaudioside X), Rebaudioside N, Rebaudioside O, Stevioside, Steviolbioside, Dulcoside A, Rubusoside, etc., or synthetic steviol glycosides, e.g. enzymatically glucosylated steviol glycosides and combinations thereof.

As used herein, the terms “high potency sweetener,” “high-potency sweetener,” and “HP sweetener,” terms that can be used interchangeably, refers to a sweetening agent that can be synthetic or natural in origin, with a sweetness potency greater than sucrose, e.g., a sweetness potency that can be about 2-fold-15,000-fold greater than sucrose. HP sweeteners are essentially non-caloric and used widely in manufacturing of diet and reduced calorie food. In general, HP sweeteners do not affect the blood glucose level and provide little or no nutritive value. Non-limiting examples of natural HP sweeteners include Stevioside, Rebaudioside A, Rebaudioside B, Rebaudioside C, Rebaudioside E, Rebaudioside F, Steviolbioside, Dulcoside A, Steviolbioside, Rubusoside, combinations thereof, and others. Additional examples of natural HP sweeteners are described herein below. It should be noted that HP sweeteners can be derived from the modification of natural high intensity sweeteners, for example, by fermentation, enzymatic treatment, or derivatization.

A “flavor” herein refers to the perception of taste and/or smell in a subject, which include sweet, sour, salty, bitter, umami, and others. The subject may be a human or an animal.

A “flavoring agent” herein refers to a compound or a biologically acceptable salt thereof (or a composition containing such) that induces a flavor or taste in an animal or a human.

A “flavor modifier” herein refers to a compound or biologically acceptable salt thereof (or a composition containing such) that modulates, including enhancing or potentiating, and inducing, the tastes and/or smell of a natural or synthetic flavoring agent in an animal or a human.

A “flavor enhancer” herein refers to a compound or biologically acceptable salt thereof (or a composition containing such) that enhances and/or multiplies the tastes or smell of a natural or synthetic flavoring agent, or a comestible composition comprising the flavor enhancer.

As used herein, “flavors with modifying properties” or “FMP” can be used interchangeably, and refer to those generally recognized as safe (GRAS) ingredients that enhance, subdue or otherwise effect other flavors without themselves being sweeteners or flavorings. The Flavor and Extracts Manufacturing Association (FEMA) has developed a protocol published in the November 2013 Edition of Food Technology.

As used herein, the term “FEMA GRAS” means that an ingredient has been designated as generally recognized as safe by an independent Flavor Expert Panel for use in flavors, e.g., see Expert Panel, Toxicology, Decision Tree, Consumption Ratio, and Chart 486—FEMA GRAS Lists Numbers Included, FDA GRAS, Bulk Flavor Labeling Statement.

As used herein, “taste” refers to a sensation caused by activation of target taste receptor cells in the taste buds of a subject. Taste can be selected from the group consisting of sweet, sour, salt, bitter, and umami. A taste can be elicited in a subject by a “tastant,” which can be a synthetic tastant, a tastant prepared from a natural source (i.e., a natural tastant), or combinations thereof.

As used herein, the terms “modulates” or “modifies” refers an increase or decrease in the amount, quality or effect of a particular activity of a receptor and/or an increase or decrease in the expression, activity or function of a receptor. “Modulators,” as used herein, refer to any inhibitory or activating compounds identified using in silico, in vitro and/or in vivo assays for, e.g., agonists, antagonists and their homologs, including fragments, variants and mimetics.

“Inducers,” “activators” or “agonists,” as used herein, refer to modulating compounds that increase, induce, stimulate, open, activate, facilitate, enhance activation, sensitize or upregulate a receptor or pathway of interest.

The terms “polypeptide,” “peptide,” “amino acid sequence” and “protein,” used interchangeably herein, refer to a molecule formed from the linking of at least two amino acids. The link between one amino acid residue and the next is an amide bond and is sometimes referred to as a peptide bond. The terms can apply to amino acid polymers in which one or more amino acid residue is an artificial chemical mimetic of a corresponding naturally occurring amino acid, as well as to naturally occurring amino acid polymers and non-naturally occurring amino acid polymers.

The term “amino acid,” as used herein, refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified, e.g., hydroxyproline, gamma-carboxyglutamate and O-phosphoserine. Amino acid analogs and derivatives can refer to compounds that have the same basic chemical structure as a naturally occurring amino acid, i.e., a carbon that is bound to a hydrogen, a carboxyl group, an amino group and an R group, e.g., homoserine, norleucine, methionine sulfoxide and methionine methyl sulfonium. Such analogs can have modified R groups (e.g., norleucine) or modified peptide backbones, but retain the same basic chemical structure as a naturally occurring amino acid. Amino acid mimetics means chemical compounds that have a structure that is different from the general chemical structure of an amino acid, but that functions in a manner similar to a naturally occurring amino acid.

As used herein, the term “effective amount” refers to an amount that is sufficient to achieve the desired modification of a physical property of the composition or material. For example, an “effective amount” of a disclosed sweetener composition or a sweetening agent refers to an amount that is sufficient to achieve the desired improvement in the property modulated by the formulation component, e.g., achieving the desired level of sweetness, sweetness appearance time, sweetness linger, sweetness desensitization, body/mouthfeel, sourness, saltiness, bitterness, or astringency. According to aspects of the present disclosure, an “effective amount” is amount that allows for a desired level of sweetness following a reduction of sugar (for example 30-50% reduction) in the target food or beverage composition to which the sweetening composition is added. In certain aspects, an “effective amount” is an amount of a sweetener or sweetener components (each with an effective amount that provides an effective amount of the composition as a whole) that, when added to a diluted beverage formulation, provides for a beverage composition with the same taste profile and no perceptible statistically-significant differences (p>0.05) in sensory attributes as the undiluted beverage formulation according to Quantitative Descriptive Analysis® (see, for example, “Stone, H., Sidel, J., Oliver, S., Woolsey, A., and Singleton, R. C., (1974). Sensory evaluation by quantitative descriptive analysis. Food Technol. 28(11), 24, 26, 28, 29, 32, 34.” and “Kemp, S. E., Hollowood T., Hort J. Sensory Evaluation: A Practical Handbook (Wiley-Blackwell 2009)” (in particular pages 111 and 163 of “Sensory Evaluation: A Practical Handbook” for discussion of Quantitative Descriptive Analysis methodology, both references being incorporated herein by reference in their entireties). The specific level in terms of wt % or % w/w in a composition required as an effective amount will depend upon a variety of factors including the amount and type of sweetener, amount and type of taste modulator, amount and type of salts and/or cations, and end use of the product made using the composition.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

### Sweetening Agents

The sweetening agent (also referred to herein as natural HP sweetener, HP sweetener, sweetener, sweetener composition, and the like) used in the disclosed sweetener compositions can be a single sweetening agent or mixture of sweetening agents. It is understood that a natural sweetener, a synthetic sweetener, a semi-synthetic sweetener, and combinations thereof, are all within the scope of the disclosed sweetener compositions. Natural sweeteners can include, but are not limited to, natural HP sweeteners, natural polyol sweeteners, natural protein sweeteners, and/or natural carbohydrate sweeteners.

Certain naturally-occurring terpene glycosides are both intensely sweet and non-calorific. For these reasons, terpene glycosides are very attractive for use as a sweetening agent in the food, beverage and dietary supplement industries. Accordingly, in various aspects, the disclosed sweetening agent can comprise a naturally occurring terpene glycoside derived from or present in a plant.

In a further aspects the sweetening agent can be a natural HP sweetener such as a Stevia rebaudiana-derived sweetener (i.e., a stevia sweetener) comprising one or more terpene glycosides extracted from any part of the plant.

Stevia is a genus of about 240 species of herbs and shrubs in the sunflower family (Asteraceae), native to subtropical and tropical regions from western North America to South America. The plant has been successfully grown under a wide range of conditions from its native subtropics to the cold northern latitudes. Steviol glycosides have zero calories and can be used wherever sugar is used. They are ideal for diabetic and low calorie diets. In addition, the sweet steviol glycosides possess functional and sensory properties superior to those of many high potency sweeteners.

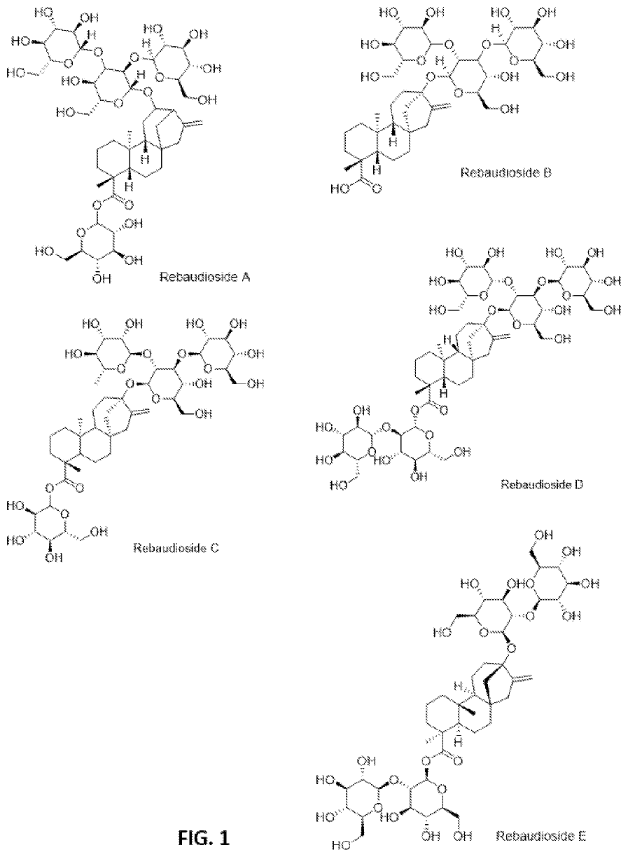

The species Stevia rebaudiana, commonly known as sweetleaf, sweet leaf, sugarleaf, or simply stevia, is a perennial shrub of the Asteraceae (Compositae) family native to certain regions of South America widely grown for its sweet leaves. Stevia rebaudiana is best known for its sweetness, although the genus includes other members (e.g., S. eupatoria, S. ovata, S plurnrnerae, S. saiicifolia, and S. serrata), which may also produce sweet tasting glycosides. The leaves have been traditionally used for hundreds of years in Paraguay and Brazil to sweeten local beverages, foods and medicines. Stevia-based sweeteners can be obtained by extracting one or more sweet compounds from the leaves. Many of these compounds are steviol glycosides. These can be purified from the leaves in various ways, including as extracts. As sweeteners and sugar substitutes, many steviol glycoside extracts have a slower sweetness onset and longer duration than that of sugar. Some of the extracts may have a bitter or licorice-like aftertaste, particularly at high concentrations, hence the usefulness of the presently disclosed taste modulators. Examples of steviol glycosides are described in WO 2013/096420 (see, e.g., listing in FIG. 1); in Ohta et al., “Characterization of Novel Steviol Glycosides from Leaves of Stevia rebaudiana Morita,” J. Appl. Glycosi., 57, 199-209 (2010) (See, e.g., Table 5 at p. 204); and in G. J. Gerwig et al., “Stevia Glycosides: Chemical and Enzymatic Modifications of Their Carbohydrate Moieties to Improve the Sweet-Tasting Quality”, Chapter 1 in Advances in Carbohydrate Chemistry and Biochemistry, 2016, 73, pp. 1-72.

Stevia rebaudiana Bertoni, as one example, is a perennial shrub of the Asteraceae (Compositae) family native to certain regions of South America. Its leaves have been traditionally used for hundreds of years in Paraguay and Brazil to sweeten local teas and medicines. The plant is commercially cultivated in Japan, Singapore, Taiwan, Malaysia, South Korea, China, Israel, India, Brazil, Australia and Paraguay. Other varieties such as Stevia rebaudiana. Morita and the like, also are known.

The Stevia rebaudiana plant contain a mixture of different diterpene glycosides that can accumulate in leaves in an amount ranging up to about 10 to 20% of the total dry weight. These diterpene glycosides are about 150 to 450 times more potent than sugar. Structurally, the diterpene glycosides are characterized by a single aglycone, steviol, and differ by the presence of varying carbohydrate residues at positions C13 and C19 (for example, see also PCT Patent Publication WO 20013/096420). Typically, on a dry weight basis, the four major steviol glycosides found in the leaves of Stevia are Dulcoside A (0.3%), Rebaudioside C (06-1.0%), Rebaudioside A (3.8%) and Stevioside (9.1%). Other glycosides identified in Stevia extract include one or more of Rebaudioside B, D, E, F, G, H, I, J, K, L, M, N, O, Steviolbioside and Rubusoside. The leaves of other cultivars of Stevia are able to accumulate up to 10-20% (on dry weight basis) steviol glycosides. The major glycosides found in Stevia leaves are Rebaudioside A (2-10%), stevioside (2-10%), and Rebaudioside C (1-2%). Other glycosides such as Rebaudioside B, D, E, and F, Steviolbioside and Rubusoside are found at much lower levels (approx. 0-0.2%). As used herein, the term “REB” is used as a shorthand for rebaudioside. For example, REBN refers to Rebaudioside N.

Steviol glycosides differ from each other not only by molecular structure, but also by their taste properties. The physical and sensory properties are well studied for a number of the steviol glycosides. Steviol glycoside extracts can be on the order of 10× or even 500× times the sweetness potency of sugar. Because stevia glycoside extracts tend to have a reducing effect on blood glucose levels as compared to sucrose, glucose, and fructose, sweetener compositions based on one or more steviol glycosides are attractive to people on carbohydrate-controlled diets. For example, the sweetness potency of Stevioside is around 110-270 times higher than sucrose, Rebaudioside A between 150 and 320 times, and Rebaudioside C between 40-60 times more potent than sucrose. Dulcoside A is 30 times more potent than sucrose. The Stevia extract containing Rebaudioside A and Stevioside as major components showed sweetness potency around 250 times. Rebaudioside A has the least astringent, the least bitter, and the least persistent aftertaste thus possessing the most favorable sensory attributes in major steviol glycosides (Tanaka 0. (1987) Improvement of taste of natural sweeteners. Pure Appl. Chem. 69:675-683; Phillips K. C. (1989) Stevia: steps in developing a new sweeteners. In: Grenby T. H. ed. Developments in sweeteners, vol. 3. Elsevier Applied Science, London. 1-43).

Previous studies show a certain correlation between number of glycosidic residues and taste quality of a steviol glycoside. When comparing steviol glycosides, rebaudioside A (G4, having 4 glucose residues) clearly surpasses stevioside and rebaudioside B (G3, each having 3 glucose residues) in taste quality. Steviolbioside and rubusoside (G2, each having 2 glucose residues) have a taste quality that is proven to be significantly inferior to that of stevioside (G3). In addition, the taste quality of rhamnosylated glycosides is inferior compared to that of glucosylated glycosides. Tanaka, O., “Improvement of Taste of Natural Sweeteners,” Pure & Appl. Chem., Vol. 69, No. 4, pp. 675-683 (1997). Steviol glycosides with a greater number of glucose residues, for example, more than two glucose residues, show a better taste quality. Particularly mono- and di-glucosyl forms of stevioside (having 4 glucose residues (G4) and 5 glucose residues (G5) respectively) possess significantly better taste quality. Tanaka, O., “Improvement of Taste of Natural Sweeteners,” Pure & Appl. Chem., Vol. 69, No. 4. pp. 675-683 (1997).

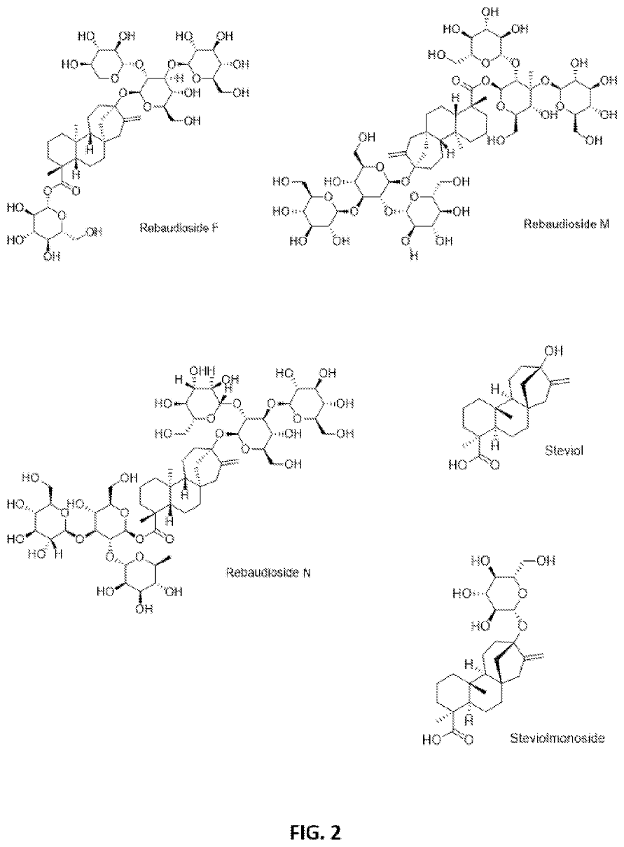

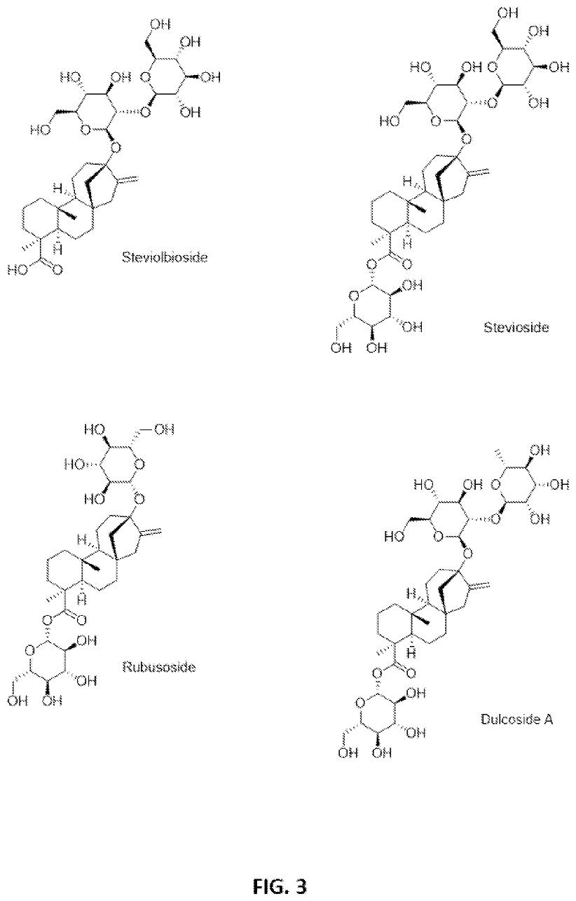

The chemical structures of some diterpene glycosides of Stevia rebaudiana are presented in FIGS. 1, 2 and 3. In a further aspect, without intending to be limiting, a stevia sweetener can comprise one or more of the stevia sweeteners shown in Table 1 below and in FIGS. 1, 2, and 3.

TABLE 1

| | Shortened | Chemical | Molecular |
|---|---|---|---|
| Common Name | Name | Formula | Weight |
| Rebaudioside A | REBA | C₄₄H₇₀O₂₃ | 967.02 |
| Rebaudioside B | REBB | C₃₈H₆₀O₁₈ | 804.88 |
| Rebaudioside C | REBC | C₄₄H₇₀O₂₂ | 951.02 |
| Rebaudioside D | REBD | C₅₀H₈₀O₂₈ | 1129.16 |
| Rebaudioside E | REBE | C₄₄H₇₀O₂₃ | 967.02 |
| Rebaudioside F | REBF | C₄₃H₆₈O₂₂ | 937.00 |
| Rebaudioside M | REBM | C₅₇H₉₂O₃₃ | 1305.33 |
| Rebaudioside N | REBN | C₅₆H₉₀O₃₂ | 1275.30 |

TABLE 2

| Common Name | IUPAC Name |
|---|---|
| Rebaudioside A | (3R,4S,5S,6R)-3,4,5-trihydroxy-6-(hydroxymethyl)tetrahydro-2H- |
| | pyran-2-yl(4R,4αS,11αR,11βS)-10-(((2R,3R,5R,6R)-5-hydroxy-6- |
| | (hydroxymethyl)-3,4-bis(((2S,3R,4S,5S,6R)-3,4,5-trihydroxy-6- |
| | (hydroxymethyl)tetrahydro-2H-pyran-2-yl)oxy)tetrahydro-2H- |
| | pyran-2-yl)oxy)-4,11β-dimethyl-8-methylenetetradecahydro-6α,9- |
| | methanocyclohepta[a]naphthalene-4-carboxylate |
| Rebaudioside B | (4R,4αS,6αR,9S,11αR,11βS)-9-(((2S,3R,5R,6R)-5-hydroxy-6- |
| | (hydroxymethyl)-4-(((2S,3R,4S,5S,6R)-3,4,5-trihydroxy-6- |
| | (hydroxymethyl)tetrahydro-2H-pyran-2-yl)oxy)-3- |
| | (((3R,4S,5S,6R)-3,4,5-trihydroxy-6-(hydroxymethyl)tetrahydro- |
| | 2H-pyran-2-yl)oxy)tetrahydro-2H-pyran-2-yl)oxy)-4,11β-dimethyl- |
| | 8-methylenetetradecahydro-6α,9-methanocyclohepta[a] |
| | naphthalene-4-carboxylic acid |
| Rebaudioside C | (3R,4S,5S,6R)-3,4,5-trihydroxy-6-(hydroxymethyl)tetrahydro-2H- |
| | pyran-2-yl (4R,6αR,9S,11βS)-9-(((2S,3R,4S,5R,6R)-5-hydroxy-6- |
| | (hydroxymethyl)-4-(((2S,3R,4S,5S,6R)-3,4,5-trihydroxy-6- |
| | (hydroxymethyl)tetrahydro-2H-pyran-2-yl)oxy)-3- |
| | (((2R,3S,4S,5S,6R)-3,4,5-trihydroxy-6-methyltetrahydro-2H- |
| | pyran-2-yl)oxy)tetrahydro-2H-pyran-2-yl)oxy)-4,11β-dimethyl-8- |
| | methylenetetradecahydro-6α,9- |
| | methanocyclohepta[a]naphthalene-4-carboxylate |
| Rebaudioside D | (2S,3R,4S,5S,6R)-4,5-dihydroxy-6-(hydroxymethyl)-3- |
| | (((2S,3R,4S,5S,6R)-3,4,5-trihydroxy-6- |
| | (hydroxymethyl)tetrahydro-2H-pyran-2-yl)oxy)tetrahydro-2H- |
| | pyran-2-yl (4R,4αS,6αR,9S,11αR,11βS)-9-(((2S,3R,4S,5R,6R)- |
| | 5-hydroxy-6-(hydroxymethyl)-3,4-bis(((2S,3R,4S,5S,6R)-3,4,5- |
| | trihydroxy-6-(hydroxymethyl)tetrahydro-2H-pyran-2- |
| | yl)oxy)tetrahydro-2H-pyran-2-yl)oxy)-4,11β-dimethyl-8- |
| | methylenetetradecahydro-6α,9-methanocyclohepta[a] |
| | naphthalene-4-carboxylate |
| Rebaudioside E | [(2S,3R,4S,5S,6R)-4,5-dihydroxy-6-(hydroxymethyl)-3- |
| | [(2S,3R,4S,5S,6R)-3,4,5-trihydroxy-6-(hydroxymethyl)oxan-2- |
| | ylloxyoxan-2-yl] (1R,4S,5R,9S,10R,13S)-13-[(2S,3R,4S,5S,6R)- |
| | 4,5-dihydroxy-6-(hydroxymethyl)-3-[(2S,3R,4S,5S,6R)-3,4,5- |
| | trihydroxy-6-(hydroxymethyl)oxan-2-yl]oxyoxan-2-ylloxy-5,9- |
| | dimethyl-14-methylidenetetracyclo[11.2.1.01,10.04,9] |
| | hexadecane-5-carboxylate |
| Rebaudioside F | (2S,3R,4S,5S,6R)-3,4,5-trihydroxy-6-(hydroxymethyl)tetrahydro- |
| | 2H-pyran-2-yl(4R,4αS,6αR,9S,11αR,11βS)-9- |
| | (((2S,3R,4S,5R,6R)-5-hydroxy-6-(hydroxymethyl)-4- |
| | (((2S,3R,4S,5S,6R)-3,4,5-trihydroxy-6- |
| | (hydroxymethyl)tetrahydro-2H-pyran-2-yl)oxy)-3- |
| | (((2S,3R,4S,5R)-3,4,5-trihydroxytetrahydro-2H-pyran-2- |
| | yl)oxy)tetrahydro-2H-pyran-2-yl)oxy)-4,11β-dimethyl-8- |
| | methylenetetradecahydro-6α,9-methanocyclohepta[a] |
| | naphthalene-4-carboxylate |
| Rebaudioside M | (2S,3R,4S,5R,6R)-5-hydroxy-6-(hydroxymethyl)-4-methyl-3,4- |
| | bis(((2S,3R,4S,5S,6R)-3,4,5-trihydroxy-6- |
| | (hydroxymethyl)tetrahydro-2H-pyran-2-yl)oxy)tetrahydro-2H- |
| | pyran-2-yl (4R,4αS,6αR,9S,11αR,11βS)-9-(((2S,3R,4S,5R,6R)- |
| | 5-hydroxy-6-(hydroxymethyl)-3,4-bis(((2S,3R,4S,5S,6R)-3,4,5- |
| | trihydroxy-6-(hydroxymethyl)tetrahydro-2H-pyran-2- |
| | yl)oxy)tetrahydro-2H-pyran-2-yl)oxy)-4,11β-dimethyl-8- |
| | methylenetetradecahydro-6α,9-methanocyclohepta[a] |
| | naphthalene-4-carboxylate |
| Rebaudioside N | (2S,3R,4S,5R,6R)-5-hydroxy-6-(hydroxymethyl)-4- |
| | (((2S,3R,4S,5S,6R)-3,4,5-trihydroxy-6- |
| | (hydroxymethyl)tetrahydro-2H-pyran-2-yl)oxy)-3- |
| | (((2S,3R,4R,5R,6S)-3,4,5-trihydroxy-6-methyltetrahydro-2H- |
| | pyran-2-yl)oxy)tetrahydro-2H-pyran-2-yl |
| | (4R,4αS,6αR,9S,11αR,11βS)-9-(((2S,3R,4S,5R,6R)-5-hydroxy- |
| | 6-(hydroxymethyl)-3,4-bis(((2S,3R,4S,5S,6R)-3,4,5-trihydroxy-6- |
| | (hydroxymethyl)tetrahydro-2H-pyran-2-yl)oxy)tetrahydro-2H- |
| | pyran-2-yl)oxy)-4,11β-dimethyl-8-methylenetetradecahydro-6,9- |
| | methanocyclohepta[a]naphthalene-4-carboxylate |

Steviol glycosides can be obtained from leaves in a variety of ways, including extraction techniques using either water or organic solvent extraction. Supercritical fluid extraction and steam distillation methods have also been described. Methods for the recovery of diterpenoid sweet glycosides from Stevia rebaudiana using supercritical CO₂, membrane technology, and water or organic solvents, such as methanol and ethanol, can also be used. Methods for the extraction and purification of sweet glycosides from the Stevia Rebaudiana plant using water and/or organic solvents are described in, for example, U.S. Pat. Nos. 4,361,697; 4,082,858; 4,892,938; 5,972,120; 5,962,678; 7,838,044 and 7,862,845. However, even in a highly purified state, steviol glycosides still possess undesirable taste attributes such as bitterness, sweet aftertaste, licorice flavor, etc. It was shown that these flavor notes become more prominent as the concentration of steviol glycosides increases (Prakash 1., DuBois G. E., Clos J. F., Wilkens K. L., Fosdick L. E. (2008) Development of Rebiana, a natural, HP sweetener. Food Chem. Toxicol., 46, S75-S82.).

Rebaudioside B (CAS No: 58543-17-2), or REBB, also known as stevioside A₄(Kennelly E. J. (2002) Constituents of Stevia Rebaudiana In Stevia: The genus Stevia, Kinghom A. D. (Ed), Taylor & Francis, London, p. 71), is one of the sweet glycosides found in Stevia Rebaudiana. Sensory evaluations show that REBB was approximately 300-350 times more potent than sucrose, while for REBA this value was approximately 350-450 (Crammer, B. and Ikan, R. (1986) Sweet glycosides from the Stevia plant. Chemistry in Britain 22, 915-916, and 918). It was believed that REBB forms from partial hydrolysis of Rebaudioside A during the extraction process (Kobayashi, M., Horikawa, S., Degrandi, I. H., Ueno, J. and Mitsuhashi, H. (1977) Dulcosides A and B, new diterpenoid glycosides from Stevia Rebaudiana. Phytochemistry 16, 1405-1408).

However further research shows that REBB occurs naturally in the leaves of Stevia Rebaudiana and currently it is one of nine steviol glycosides recognized by FAO/JECFA (United Nations' Food and Agriculture Organization/Joint Expert Committee on Food Additives) in calculating total steviol glycosides' content in commercial steviol glycosides preparations (FAO JECFA (2010) Steviol Glycosides, Compendium of Food Additive Specifications, FAO JECFA Monographs 10, 17-21). On the other hand, the water solubility of REBB is reported to be about 0.1% (Kinghorn A. D. (2002) Constituents of Stevia Rebaudiana In Stevia: The genus Stevia, Kinghorn A. D. (Ed), Taylor & Francis, London, p. 8). In many food processes where highly concentrated ingredients are used, a highly soluble form of REBB can be desirable. Rebaudioside D (CAS No: 63279-13-0), is one of the sweet glycosides found in Stevia rebaudiana. Studies have shown that highly purified forms of Rebaudioside D (REBD) possess a very desirable taste profile, almost lacking the bitterness and lingering licorice aftertaste typical for other steviol glycosides.

It is known that some of the undesired taste attributes associated with steviol glycoside molecules can be substantially reduced by the reaction of intermolecular transglycosylation of various enzymes, upon which the attachment of new carbohydrates at positions C13 and C19 of steviol glycosides takes place. The effect of adding glucose molecules to purified stevioside molecules by transglycosylation was previously evaluated (Tanaka, O., “Improvement of Taste of Natural Sweeteners,” Pure & Appl. Chem., Vol. 69, No. 4, pp. 675-683 (1997)). The resulting glucosylated steviosides were evaluated for their sweetness and taste quality and it was observed that the improvement of taste quality was greater when the glucose units were added to the C19 position rather than at the C13 position.

Various enzymes have been used to conduct such transglycosylation. Pullulanase, isomaltase (Lobov, S. V. et al., “Enzymic Production of Sweet Stevioside Derivatives: Transglucosylation by Glucosidases,” Agric. Biol. Chem., Vol. 55, No. 12, pp. 2959-2965 (1991)), β-galactosidase (Kitahata, S. et al., “Production of Rubusoside Derivatives by Transgalactosylation of Various β-Galactosidases,” Agric. Biol. Chem., Vol. 53, No. 1 1, pp. 2923-2928 (1989)), and dextrine saccharase (Yamamoto, K. et al., Biosci. Biotech. Biochem., Vol. 58, No. 9, pp. 1657-1661 (1994)) were used as enzymes with pullulan, maltose, lactose, and partially hydrolyzed starch being donors. The transglucosylation of steviol glycosides was also achieved by the action of cyclodextrin glucanotransferases (CGTase). The obtained sweeteners possessed improved sweetness without bitterness and licorice taste (U.S. Pat. Nos. 4,219,571, 7,838,044, and 7,807,206).

It has been observed that an increase in the number of glucose units in steviol glycoside molecules (for example, from stevioside to Rebaudioside A), is associated with an increase in the sweetness intensity and improvement in the sweetness profile (taste). It is known that the sweetness quality generally improves with the addition of glucose units. The number of glucose units in a glucosylated steviol glycoside can be as described in International Patent Publ. No. WO2012129451A1, e.g., at least one glucose unit, at least one glucose units, or at least one glucose units. In some instances, the least one glucose unit, at least one glucose units, or at least one glucose units is at the C-13, C-19, or both the C-13 and C-19 of the glucosylated steviol glycoside. In other instances, at least one glucose unit occurs at position C-19 of the glucosylated steviol glycoside.

In a further aspect, the disclosed sweetening agent can further comprise at least one carbohydrate sweetener selected from the group consisting of glucose, fructose, sucrose and combinations thereof, in an amount effective to provide a concentration from about 10 ppm to about 140,000 ppm when present in a sweetened composition, such as, for example, a beverage. In additional embodiments, the disclosed sweetening agent can further comprise glucose in an amount of about 20 ppm to about 500 ppm. In additional embodiments, sweetening agents as described herein contain no glucose or residual glucose.

In a further aspect, the disclosed sweetening agent can further comprise one or more carbohydrate sweeteners selected from D-allose, D-allulose, L-ribose, D-tagatose, L-glucose, fucose, L-Arabinose, Turanose and combinations thereof, in an amount effective to provide a concentration from about 10 ppm to about 140,000 ppm when present in a sweetened composition, such as, for example, a beverage. In additional embodiments, the disclosed sweetening agent can further comprise L-glucose in an amount of about 20 ppm to about 500 ppm. In additional embodiments, sweetening agents as described herein contain no residual L-glucose.

In a further aspect, the disclosed sweetening agent can be one or more natural, HP sweeteners. Suitable natural HP sweeteners include, but are not limited to, rebaudioside A, rebaudioside B, rebaudioside C, rebaudioside D, rebaudioside E, rebaudioside F, rebaudioside I, rebaudioside H, rebaudioside J, rebaudioside L, rebaudioside K, rebaudioside J, rebaudioside M (also known as rebaudioside X), rebaudioside 0, dulcoside A, dulcoside B, rubusoside, stevia, stevioside, and combinations thereof. The natural HP sweetener is present in the disclosed sweetener composition in an amount effective to provide an amount from about 0.1 ppm to about 3,000 ppm when present in a sweetened composition, such as, for example, a beverage. In embodiments according to the present disclosure, the sweetener composition is present in a final amount of about 80 to about 300 ppm when added to the sweetened composition, for example, a beverage composition. Embodiments of other amounts are described herein.

In embodiments, the disclosed sweetener composition comprises an amount effective (effective amount total and/or affective amount of individual sweetener components of the composition, such as terpene glycosides extracted from the Stevia rebaudiana species of plant, for example Stevia rebaudiana Bertoni) to provide a final concentration from about 80 ppm to about 300 ppm (or about 90 to about 290 ppm; about 100 to about 280 ppm; about 110 to about 270 ppm; about 110 to about 260 ppm; about 120 to about 250 ppm; about 130 to about 240 ppm; about 140 to about 230 ppm; about 150 to about 220 ppm; about 160 to about 210 ppm; about 170 to about 200 ppm; about 180 to about 190 ppm; about 80 to about 290 ppm; about 80 to about 280 ppm; about 80 to about 270 ppm; about 80 to about 260 ppm; about 80 to about 250 ppm; about 80 to about 240 ppm; about 80 to about 230 ppm; about 80 to about 220 ppm; about 80 to about 210 ppm; about 80 to about 200 ppm; about 80 to about 190 ppm; about 80 to about 180 ppm; about 80 to about 170 ppm; about 80 to about 160 ppm; about 80 to about 150 ppm; about 80 to about 140 ppm; about 80 to about 130 ppm; about 80 to about 120 ppm; about 80 to about 110 ppm; about 80 to about 100 ppm; about 80 to about 90 ppm; about 90 to about 300 ppm; about 100 to about 300 ppm; about 110 to about 300 ppm; about 120 to about 300 ppm; about 130 to about 300 ppm; about 140 to about 300 ppm; about 150 to about 300 ppm; about 160 to about 300 ppm; about 170 to about 300 ppm; about 180 to about 300 ppm; about 190 to about 300 ppm; about 200 to about 300 ppm; about 210 to about 300 ppm; about 220 to about 300 ppm; about 230 to about 300 ppm; about 240 to about 300 ppm; about 250 to about 300 ppm; about 260 to about 300 ppm; about 270 to about 300 ppm; about 280 to about 300 ppm; about 290 to about 300 ppm) when present in a sweetened composition, such as, for example, a beverage or diluted soft drink formulation (for example Coca-Cola® or Sprite® diluted with another aqueous solution, for example, water).

In a further aspect, the disclosed sweetening agent can comprise one or more chemically (including enzymatically) modified natural HP sweetener. Modified natural HP sweeteners include glycosylated natural HP sweetener such as glucosyl-, galactosyl-, fructosyl-derivatives containing 1-50 glycosidic residues. Glycosylated natural HIP sweeteners may be prepared by enzymatic transglycosylation reaction catalyzed by various enzymes possessing transglycosylating activity. Others include one or more sugar alcohols obtained from sugar such by using hydrogenation techniques. In some aspects, a glycosylated natural HP sweetener can be a glucosylated steviol glycoside (which can also be referred to as a “GSG”). An exemplary, but not limiting, GSG that can be used in the disclosed sweetener compositions are those marketed by Almendra under the brand name of Steviaromes™ (2050 and 5000, for example).

Non-limiting examples of HP sweeteners that can be utilized according to the present disclosure include one or more of rebaudioside A, rebaudioside B, rebaudioside C, rebaudioside D, rebaudioside E, rebaudioside F, dulcoside A, dulcoside B, rubusoside, stevia, stevioside, and total steviol glycosides. HP sweeteners also include modified HP sweeteners. Modified HP sweeteners include HP sweeteners which have been altered naturally. For example, a modified HIP sweeteners includes, but is not limited to, HIP sweeteners which have been fermented, contacted with enzyme, or derivatized or substituted on the HP sweeteners.

In another aspect, the HP sweeteners may be selected from (or otherwise include any one or more of) the group consisting of rebaudioside A, rebaudioside B, rebaudioside C, rebaudioside D, rebaudioside E, rebaudioside F, dulcoside A, dulcoside B, rubusoside, stevia, stevioside, mogroside IV, mogroside V, Luo Han Quo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, saccharin and its salts, cyclamic acid and its salts, aspartame, aspartame-acesulfame salt, acesulfame potassium, sucralose, alitame, neotame, neohesperidin dihydrochalone (NHDC), advantame and combinations thereof.

In a further aspect, the disclosed sweetening agent can comprise REBA, REBB, REBC, REDD, REBE, REBF, REBM, REBN, stevioside, steviolbioside, dulcoside, rubsoside, or combinations thereof, and at least one other sweetener that in combination function as the sweetening agent (i.e. the substance or substances that provide sweetness) of a disclosed sweetener composition. The disclosed sweetener compositions often exhibit synergy when individual sweetener compounds are combined and have improved flavor and temporal profiles compared to each sweetener alone. One or more additional sweetening agents can be used in the disclosed sweetener compositions. In a yet further aspect, disclosed sweetener compositions comprise REBA and at least one additional sweetener. In a still further aspect, a sweeteners composition contains REBB and at least one additional sweetener. In an even further aspect, a sweeteners composition contains REBC and at least one additional sweetener. In a still further aspect, a sweeteners composition contains REBD and at least one additional sweetener. In a yet further aspect, a sweeteners composition contains REBE and at least one additional sweetener. In an even further aspect, a sweeteners composition contains REBF and at least one additional sweetener. In a still further aspect, a sweeteners composition contains REBM and at least one additional sweetener. In a yet further aspect, a sweeteners composition contains REBN and at least one additional sweetener. In a yet further aspect, a sweeteners composition contains Steviolbioside and at least one additional sweetener, for example, REBA, REBC, or both. HP sweeteners according to the present disclosure can also be combined with other HP sweeteners, for example, Steviarome®2050 and Steviarome®5000. HP sweeteners according to the present disclosure (such as steviol glycoside compositions) can also be combined with other sweeteners, for example, sucralose and/or erythritol.

### Sweetener Compositions

In various aspects, the present disclosure, relates to sweetener compositions comprising a sweetening agent.

As noted herein above, frequently HP sweeteners differ significantly from natural caloric sugars in ways that frustrate consumers and limit market penetration of products containing many HP sweeteners. Accepted metrics for commercial viability of a HP sweetener include: 1) Taste Quality; 2) Safety; 3) Solubility; 4) Stability; and 5) Cost. With regard to Taste Quality, HP sweeteners exhibit temporal profiles, maximal responses, flavor profiles, mouthfeels, and often desensitization/adaptation behaviors that differ from sugar. Specifically, HP sweeteners frequently exhibit one or more of the following problems or issues:
Rₘ Problem: Insufficient Maximal Sweetness Response;
Flavor Profile Problem: Bitter and Licorice-Like Off-tastes;
Temporal Profile Problem: Delay in Sweetness Onset and Lingering Sweet Aftertaste (Sweetness Linger=SL);
Desensitization/Adaptation Profile Problem: Sweetness causing a Desensitization of the Taste System and/or Reduction in Perceived Sweetness on Iterative Tasting; and
Body/Mouthfeel Problem: Absence of Body/Mouthfeel common in Sugar-Sweetened Formulations.

Attempts have been made in the industry to address the Taste Quality issues associated with many HP sweeteners. However, although some of the currently available taste modulators are able to address the Taste Quality issues, these known taste modulators add unacceptable cost that make their use in common food and beverage products impractical; provide only limited modulation of Taste Quality problems, thus limiting their widespread use; are associated with regulatory or potential toxicity issues; or combinations of all these shortcomings.

The major application of HP sweeteners has been and will continue to be 0-calorie and calorie-reduced beverages. Thus, with regard to the cost metric discussed above, representative cost considerations for a HP sweetener can be assessed at a first approximation on the basis of cost impact for beverage use. Beverage manufacturers typically determine ingredient costs on a Cost per Unit Case (CUC) basis, where a Unit Case is 24-8 ounce bottles (ca. 5.7 L). For purpose of illustration, in the US at the present time, the sweetener system CUCs for a sucrose-sweetened beverage is about $0.60, a high-fructose corn syrup-sweetened beverage is about $0.50, an aspartame-sweetened beverage is about $0.04 and an aspartame/acesulfame-K sweetened beverage is about $0.03.

In contrast, the use of many HP sweeteners cannot be used in typical beverage or food products because they often require a taste modulator to address the Taste Quality issues noted above. In particular, currently available taste modulators add significant cost to the use of many HP sweeteners. For example, a beverage using a sweetener formulation comprising rebaudioside A is understood in the industry to require the use of a taste modulator such as meso-erythritol in order to achieve desired Taste Quality metrics described above. However, at the levels required for beverage use, a rebaudioside A/meso-erythritol formulation is estimated to cost about $1.20 to about $1.50 on a CUC basis. Thus, although the use of a natural sweetener, such as rebaudioside A, in a beverage product is highly desirable in many respects, the use in such a context is cost prohibitive.

The amount or relative amounts of the sweetening agent and the taste modulator in a disclosed sweetener composition are determined, in part, by the application or use of the disclosed sweetener composition and the product context. That is, the amount of the sweetening agent and the taste modulator in a disclosed sweetener composition in a beverage, a food product, a nutraceutical, a pharmaceutical, and the like will be determined by the requirements for sweetness intensity in a particular product use. In addition, the amount or relative amounts of the sweetening agent and the taste modulator in a disclosed sweetener composition is determined, in part, by established the Dietary Reference Intakes (DRIs) for salts used in the taste modulator, including various regulatory agencies and health or scientific bodies and organizations. For example, exemplary DRIs have been published by the Institute of Medicine of the National Academies of the United States (see: Dietary Reference Requirements: The Essential Guide to Nutrient Requirements, J. J. Otten, J. Pitzi Hellwig, L. D. Meyers, Eds., The National Academies Press, 2006, Washington, D.C.).

In various aspects, the sweetening agent is present in the disclosed sweetener compositions in an amount effective to provide a concentration when present in a beverage, food, nutraceutical, pharmaceutical, or cosmetic from about 1 mg/L to about 1000 mg/L or about 80 ppm to about 300 ppm, or other amounts as described herein.

In a further aspect, the sweetening agent is present in the disclosed sweetener compositions in an amount effective to provide a concentration when present in a beverage, food, nutraceutical, pharmaceutical, or cosmetic from about 0.1 mg/L to about 1000 mg/L if the sweetener is a non-caloric sweetener or from about 1.0 wt % to about 15 wt % if the sweetener is a caloric sweetener.

In various aspects, the amount effective described above can be in the form of a concentrate such that when utilized in a beverage, a food item, and the like, it is diluted to the disclosed amounts effective described herein above. As such, a concentrate can have an amount effective that is 2- to 100-fold greater than the amount effective for a concentration that is directly consumed or utilized in a product such as a beverage, a food item, and the like.

A disclosed sweetener composition can be present in the various forms. For example, the disclosed sweetener composition can be present as a powder, a particulate, an agglomerated solid, a solid, a gel, a tablet, or combinations thereof. In some cases, the disclosed sweetener can be present as a powder, a particulate, an agglomerated solid, or another essentially solid form. As used herein, “agglomerated solid” means a plurality of disclosed sweetener composition particles clustered and held together. Examples of agglomerated solids include, but are not limited to, binder held agglomerates, tablets, extrudates, and granules.

In a further aspect, the disclosed sweetener composition can be present in a liquid, gel, or solution form, including such forms as a beverage, a food item, a nutraceutical, a pharmaceutical, a cosmetic item, or concentrate that can be used as an additive to or in the preparation of a beverage, a food item, a nutraceutical, a pharmaceutical, a cosmetic item. Sweeteners according to the present disclosure can further comprise a food acceptable buffer such as a citric acid buffer or phosphoric acid buffer. Disclosed forms of the disclosed sweetener compositions include forms that are co-crystallized sweetener compositions with a sugar or a polyol, an agglomerated sweetener composition, a compacted sweetener composition, a dried sweetener composition, a particle sweetener composition, a spheronized sweetener composition, a granular sweetener composition, and a liquid sweetener composition.

In various aspects, a disclosed sweetener composition can further comprise an additive such as a liquid carrier, binder matrix, additional additives, and/or the like as detailed herein below. In some aspects, the disclosed sweetener composition contains additives including, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, weighting agents, gums, antioxidants, colorants, flavonoids, alcohols, polymers and combinations thereof. In some aspects, the additives act to improve the temporal and flavor profiles of the sweetener to provide a sweetener composition with a favorable taste, such as a taste similar to sucrose.

In a further aspect, the disclosed sweetener composition contain one or more polyols. The term “polyol”, as used herein, refers to a molecule that contains more than one hydroxyl group. In some aspects, a polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, 7, or even more hydroxyl groups, respectively. Additionally, a polyol also may be a sugar alcohol, polyhydric alcohol, polymer comprising OH functionality, or polyalcohol which is a reduced form of a carbohydrate, wherein a carbonyl group (aldehyde or ketone, reducing sugar) has been reduced to a primary or secondary hydroxyl group. In various aspects, polyols can include erythritol, xylitol, sorbitol, lactitol, isomalt, maltitol, reduced isomalto-oligosaccharides, reduced xylo-oligosaccharides, reduced gentio-oligosaccharides, reduced maltose syrup, reduced glucose syrup, and combinations thereof. In a further aspect, polyols can include erythritol, xylitol, sorbitol, lactitol, isomalt, galactitol, and maltitol, and combinations thereof. In a further aspect, polyols can include erythritol. In a further aspect, a polyol can be derived by reduction of isomaltulose, or sugar alcohols or any other carbohydrates capable of being reduced which do not adversely affect the taste of the disclosed sweetener composition.

In a further aspect, a polyol can be present in an amount effective to provide a concentration from about 100 ppm to about 250,000 ppm when present in a sweetened composition, such as, for example, a beverage, based on the total weight of the sweetened composition. In other aspects, the polyol is present in the disclosed sweetener composition in an amount effective to provide a concentration from about 400 ppm to about 80,000 ppm when present in a sweetened composition, such as, for example, from about 5,000 ppm to about 40,000 ppm, based on the total weight of the sweetened composition. As used herein, the term “ppm” refers to part(s) per million by weight, for example, of a given material, e.g., a compound, component, sweetening agent, disclosed taste modulator (and components that make up a taste modulator), or additive in a composition or product containing the given material; including, example, the milligrams of a given material per kilogram of a composition or product containing the given material (i.e., mg/kg); the milligrams of a given material per liter of a composition or product containing the given material (i.e., mg/L); or the volume of a given material (in microliters) per liter a composition or product containing the given material (i.e., μl/L).

In a further aspect, suitable sugar acid additives include, but are not limited to, aldonic, uronic, aldaric, alginic, gluconic, glucuronic, giticaric, galactaric, galacturonic, and salts thereof (e.g., sodium, potassium, calcium, magnesium salts or other physiologically acceptable salts), and combinations thereof.

In some instances, the present disclosure, relates to sweetener compositions comprising a sweetening agent and a disclosed taste modulator composition that provide a mid-calorie beverage, e.g., a calorie reduction of about 33% to about 75% compared to a standard beverage comprising one or more caloric sweetener such as sucrose, fructose (in the form of HFCS-55 or HFCS-42), and the like similar caloric sweeteners. The beverage industry in recent years has shown strong interest in formulation of such mid-calorie beverages. In such mid-calorie beverage formulations, would contain a caloric sweetener (e.g. sucrose, HFCS-55, HFCS-42 or even glucose), providing 67% to 50% to 25% of the sweetness in the beverage product. The remainder of the sweetness in such products, generally, must be provided by a non-caloric sweetener. And such non-caloric sweeteners may be synthetic non-caloric sweeteners, e.g., saccharin, cyclamate, aspartame, acesulfame-K, sucralose, neotame and advantame; or natural non-caloric sweeteners, e.g., Stevia Sweeteners (i.e., REBA, REBD, REBM, etc.), Monk Fruit Sweeteners (i.e., mogroside V, siratose, etc.), Protein Sweeteners (i.e., thaumatin, brazzein, etc.); and mixtures of one more synthetic non-caloric sweeteners, one or more natural non-caloric sweeteners, and combinations thereof. All such blends of caloric sweeteners and non-caloric sweeteners can be improved in taste (i.e., reduction in sweetness linger and increase in body/mouthfeel) by utilizing the disclosed taste modulator compositions and sweetener compositions of the present disclosure.

### Beverage Compositions

In various aspects, the present disclosure, relates to beverage compositions comprising at least one disclosed sweetening agent (also described herein as sweetener or sweetener composition, among others). Beverage compositions comprising sweeteners as described herein allow for a reduction in the amount of sugar in the beverage (for example 30-50%) without changing the perceivable sensory attributes of the “regular” beverage formulation with non-reduced sugar levels (and no additional sweeteners).

According to embodiments of the present disclosure, beverage compositions as described herein can be cola or lemon-lime flavored (carbonated or non-carbonated) beverages with reduced sugar amounts (30-50%) and comprising sweetener compositions according to the present disclosure.

Flavoring Compositions, Flavor Modifier Compositions and Flavorings with Modifying Properties

The disclosed taste modulator compositions can be used as flavor or taste modifiers, such as a flavoring or flavoring agents and flavor or taste enhancers, more particularly, sweet taste modifiers, sweet flavoring agents, sweet flavor enhancers, for foods, beverages, and other comestible or orally administered medicinal or nutraceutical products or compositions. In some aspects, the disclosed taste modulator compositions can be used without a flavor, flavor modifier, flavor agent, flavor enhancer, or flavoring with modifying properties for comestible products. In other aspects, the disclosed taste modulator compositions are used with one or more a flavor, flavor modifier, flavor agent, flavor enhancer, or flavoring with modifying properties for comestible products. In a further aspect, the disclosed taste modulator compositions can be used in a flavoring with modifying properties composition comprising a disclosed modulator composition and one or more flavor, flavor modifier, flavor agent, flavor enhancer, or flavoring.

The suitable amount of the disclosed taste modulator compositions to use with one or more flavor, flavor modifier, flavor agent, flavor enhancer, or flavoring with modifying properties can be assessed and further optimized using a suitable sensory testing methodology, e.g., the sensory testing methodology described herein below for sensory assessment of sweetness. Moreover, such a sensory test methodology can be useful in identifying suitable disclosed taste modulator compositions (and concentrations of same) to be used in combination with flavor, flavor modifier, flavor agent, flavor enhancer, or flavoring with modifying properties. The sensory test methodology described herein below can be well quantified and controlled by tasting the candidate compounds in aqueous solutions, as compared to control aqueous solution, or alternatively by tasting the disclosed taste modulator compositions of the disclosure in actual food compositions.

In various aspects, the disclosed taste modulator compositions, either alone or in combination with one or more flavor, flavor modifier, flavor agent, flavor enhancer, or flavoring with modifying properties have application in foods, beverages and other comestible compositions wherein sweet compounds are conventionally utilized. These compositions include compositions for human and animal consumption. This includes food or drinks (liquids) for consumption by agricultural animals, pets and zoo animals Those of ordinary skill in the art of preparing and selling comestible compositions (e.g., edible foods or beverages, or precursors or flavor modifiers thereof) are well aware of a large variety of classes, subclasses and species of the comestible compositions, and utilize well-known and recognized terms of art to refer to those comestible compositions while endeavoring to prepare and sell various of those comestible compositions. Such a list of terms of art is enumerated below, and it is specifically contemplated hereby that the disclosed taste modulator compositions could be used to modify or enhance the sweet flavors of the following list comestible compositions, either singly or in all reasonable combinations or mixtures thereof: one or more confectioneries, chocolate confectionery, tablets, boxed assortments, standard boxed assortments, twist wrapped miniatures, seasonal chocolate, chocolate with toys, other chocolate confectionery, mints, standard mints, power mints, boiled sweets, pastilles, gums, jellies and chews, toffees, caramels and nougat, medicated confectionery, lollipops, licorice, other sugar confectionery, gum, chewing gum, gum with one or more sweeteners, sugar-free gum, functional gum, bubble gum, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, cereals, family breakfast cereals, flakes, muesli, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yogurt, artisanal ice cream, dairy products, milk, fresh/pasteurized milk, full fat fresh/pasteurized milk, semi skimmed fresh/pasteurized milk, full fat milk, semi skimmed milk, fat-free milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, cheese, processed cheese, spreadable processed cheese, non-spreadable processed cheese, unprocessed cheese, spreadable unprocessed cheese, hard cheese, packaged hard cheese, unpackaged hard cheese, yogurt, plain/natural yogurt, flavored yogurt, fruited yogurt, probiotic yogurt, drinking yogurt, regular drinking yogurt, probiotic drinking yogurt, chilled and shelf-stable desserts, dairy-based desserts, soy-based desserts, chilled snacks, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and Seed oil, cooking fats, butter, margarine, spreadable oils and fats, functional spreadable oils and fats, sauces, dressings and condiments, tomato pastes and purees, bouillon/stock cubes, stock cubes, gravy granules, liquid stocks, herbs and spices, fermented sauces, soy based sauces, pasta sauces, wet sauces, dry sauces/powder mixes, ketchup, mayonnaise, regular mayonnaise, mustard, salad dressings, regular salad dressings, low fat salad dressings, vinaigrettes, dips, pickled products, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, and yeast-based spreads.

In a further aspect, the disclosed taste modulator compositions can be used to modify or enhance the sweet flavor of one or more of the following sub-groups of comestible compositions: confectioneries, bakery products, ice creams, dairy products, sweet snacks, snack bars, meal replacement products, ready meals, soups, pastas, noodles, canned foods, frozen foods, dried foods, chilled foods, oils and fats, baby foods, or spreads, or a mixture thereof.

In general an ingestible composition will be produced that contains a sufficient amount of the disclosed taste modulator compositions described hereinabove to produce a composition having the desired flavor or taste characteristics such as “sweet” taste characteristics.

Typically at least a sweet flavor modulating amount, of one or more of the disclosed taste modulator compositions can be added to the comestible product, so that the sweet flavor modified comestible product has an increased sweet taste as compared to the comestible product prepared without the disclosed taste modulator compositions, as judged by human beings or animals in general, or in the case of formulations testing, as judged by a majority of a panel of human taste testers, via procedures described elsewhere herein.

The concentration of sweet flavor agent needed to modulate or improve the flavor of the comestible product or composition will of course vary dependent on many variables, including the specific type of ingestible composition, what sweet compounds are already present and the concentrations thereof, the amount of presence of other flavors with modifying properties, and the enhancer effect of the particular compound on such sweet compounds. As noted, an application of the disclosed taste modulator compositions is for modulating (inducing, enhancing or inhibiting) the sweet tastes or other taste properties of other natural or synthetic sweet tastants. A broad range of concentrations of the disclosed taste modulator compositions can be employed to provide such sweet taste enhancement as described herein elsewhere.

Examples of foods and beverages wherein the disclosed taste modulator compositions may be incorporated included byway of example the Wet Soup Category, the Dehydrated and Culinary Food Category, the Beverage Category, the Frozen Food Category, the Snack Food Category, and seasonings or seasoning blends. “Wet Soup Category” means wet/liquid soups regardless of concentration or container, including frozen Soups. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consomme) to sauces (cream or cheese-based soups).

“Dehydrated and Culinary Food Category” means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

“Beverage Category” means beverages, beverage mixes and concentrates, including but not limited to, alcoholic and non-alcoholic ready to drink and dry powdered beverages. Other examples of foods and beverages wherein compounds according to the disclosure may be incorporated included by way of example carbonated and non-carbonated beverages, e.g., sodas, fruit or vegetable juices, alcoholic and non-alcoholic beverages, confectionary products, e.g., cakes, cookies, pies, candies, chewing gums, gelatins, ice creams, sorbets, puddings, jams, jellies, salad dressings, and other condiments, cereal, and other breakfast foods, canned fruits and fruit sauces and the like.

Additionally, the subject compounds can be used in flavor preparations to be added to foods and beverages. In preferred instances the composition will comprise another flavor or taste modifier such as a sweet tastant.

Accordingly, in some aspects, the disclosure relates to methods for modulating the sweet taste of a comestible product comprising: a) providing at least one comestible product, or a precursor thereof, and b) combining the comestible product or precursor thereof with at least a sweet flavor modulating amount of the disclosed taste modulator compositions, so as to form a modified comestible product.

The disclosure also relates to the modified comestible products produced by such processes, and similar processes for producing comestible products well known to those of ordinary skill in the art, especially if such compositions comprise other flavorings with modifying properties. The disclosed taste modulator compositions can be combined with or applied to the comestible or medicinal products or precursor thereof in any of innumerable ways known to cooks the world over, or producers of comestible or medicinal products. For example, the disclosed taste modulator compositions can be dissolved in or dispersed in or one of many known comestibly acceptable liquids, solids, or other carriers, such as water at neutral, acidic, or basic pH, fruit or vegetable juices, vinegar, marinades, beer, wine, natural water/fat emulsions such as milk or condensed milk, edible oils and shortenings, fatty acids, certain low molecular weight oligomers of propylene glycol, glyceryl esters of fatty acids, and dispersions or emulsions of such hydrophobic substances in aqueous media, salts such as sodium chloride, vegetable flours, solvents such as ethanol, solid edible diluents such as vegetable powders or flours, and the like, and then combined with precursors of the comestible or medicinal products, or applied directly to the comestible or medicinal products.

Steviol glycosides, stevia-derived sweeteners, and stevia-derived extracts provide sweetness and other taste attributes at a higher than certain threshold level of concentrations in water. Below the threshold level of concentration, the steviol glycosides, stevia-derived sweeteners, stevia-derived extracts, and their mixtures have no recognizable sweetness taste, but such stevia extract below the threshold level of significant sweetness recognition can be associated with sweet and flavor profile modification in food and beverage applications. Accordingly, in various aspects, the present disclosure pertains to flavorings with modifying properties comprising a disclosed taste modulator composition and at least one steviol glycoside, stevia-derived sweetener, stevia-derived extract, and combinations thereof, such that the at least one steviol glycoside, stevia-derived sweetener, stevia-derived extract, and combinations thereof is present in an amount less than 1.5 wt % sucrose equivalent. In some aspects, the least one steviol glycoside, stevia-derived sweetener, stevia-derived extract, and combinations thereof comprises one or more glucosylated steviol glycoside.

In further aspects, the present disclosure pertains to flavorings with modifying properties comprising: (a) a disclosed taste modulator composition; (b) at least one Siraitia grosvenorii (luo han guo or monk fruit)-derived sweetener, extract, juice, and combinations thereof, such that the at least one Siraitia grosvenorii (luo han guo or monk fruit)-derived sweetener, extract, juice, and combinations thereof is present in an amount less than 1.5 wt % sucrose equivalent; and (c) at least one steviol glycoside, stevia-derived sweetener, stevia-derived extract, and combinations thereof, such that the at least one steviol glycoside, stevia-derived sweetener, stevia-derived extract, and combinations thereof is present in an amount less than 1.5 wt % sucrose equivalent. In some aspects, the least one steviol glycoside, stevia-derived sweetener, stevia-derived extract, and combinations thereof comprises one or more glucosylated steviol glycoside.

In certain aspects, the present disclosure is directed to a taste and flavor modifying composition. In certain aspects, taste and flavor modifying compositions as described herein (also referred to herein as sweeteners or sweetener compositions or other names as described herein) provide for a food or beverage product with a reduced sugar amount but perceivably sensorially similar to the same food or beverage product without a reduced sugar amount (according to methodology at least as described herein). The disclosed taste and flavor modifying composition, which can modify the intensity of a taste and/or a flavor in a food or beverage product, comprises a disclosed taste modulator composition and at least one steviol glycoside, stevia-derived sweetener, stevia-derived extract, and combinations thereof, comprising one or more steviol glycosides with other water soluble molecules derived from Stevia plant, such as non-limiting examples of plant glycosides, flavonoids, labdane diterpene, triterpenes.

The present disclosure is also directed to a food or beverage product having a total reduced sugar amount but imperceivable from a sensory perspective to the same food or beverage product having a non-reduce sugar level (according to methodology as described herein), wherein the food or beverage product comprises a disclosed taste and flavor modifying composition, which can modify the intensity of a taste and/or a flavor in a food or beverage product, comprises a disclosed taste modulator composition and at least one steviol glycoside, stevia-derived sweetener, stevia-derived extract, and combinations thereof, comprising one or more steviol glycosides with other water soluble molecules derived from Stevia plant, such as non-limiting examples of plant glycosides, flavonoids, labdane diterpene, triterpenes. A wide range of food and beverage products, such as, but not limited to, carbonated soft drinks. The taste and flavor profile of a food or beverage product comprising a taste and flavor modifying composition, wherein the taste and flavor modifying composition comprising the stevia extract of steviol glycosides and water soluble molecules derived from stevia plant, may be more intense than a comparative taste and flavor profile of a comparative food or beverage product which does not include the taste and flavor modifying composition. Moreover, the mouthfeel and overall taste perception of a food or beverage product comprising the taste and flavor modifying composition, wherein the taste and flavor enhancing composition includes the complex mixture of steviol glycosides and water soluble molecules, may be improved in relation to a mouthfeel and overall taste perception of a comparative food or beverage product which does not include the taste and flavor enhancing composition.

The present disclosure is further directed to a method of increasing the taste and flavor intensity of a diluted beverage product (for example bringing the sensory perception of a reduced-sugar food or beverage back to its normal, non-sugar reduced sensory perception by the addition of a sweetener according to methods of the present disclosure), comprising the steps of diluting a beverage product (with water, for example); adding a sweetener composition to the diluted beverage product, wherein the sweetener composition comprises one or more components of the stevia extract of steviol glycosides and water soluble molecules derived from stevia plant (aspects of such compositions discussed herein in the disclosure and Examples).

The present disclosure is further directed to a method of increasing the taste and flavor intensity of a diluted beverage product (for example bringing the sensory perception of a reduced-sugar food or beverage back to its normal, non-sugar reduced sensory perception by the addition of a sweetener), comprising the steps of diluting a beverage product (with water, for example); adding an effective amount of a sweetener composition to the diluted beverage product, wherein the effective amount of the sweetener composition comprises one or more components of the stevia extract of steviol glycosides and water soluble molecules derived from stevia plant (aspects of such compositions discussed herein in the disclosure and Examples) in an amount to make the taste profile of the sweetened diluted beverage product indistinguishable from the undiluted beverage product (for example a final amount of the sweetener composition as described herein in the diluted beverage product present in an amount of about 80 to about 300 ppm, or other amounts as described herein).

The present disclosure is further directed to a method of increasing the taste and flavor intensity of a food or beverage product (for example bringing the sensory perception of a reduced-sugar food or beverage back to its normal, non-sugar reduced sensory perception by the addition of a sweetener), comprising the step of adding a taste and flavor enhancing composition to the food or beverage product, wherein the taste and flavor modifying composition comprising the stevia extract of steviol glycosides and water soluble molecules derived from stevia plant. The present disclosure is also directed to a method of improving the organoleptic properties of a food or beverage product comprising a high fructose syrup, comprising the step of adding the taste and flavor modifying composition to the food or beverage product. For example, adding the taste and flavor modifying composition may cause the high fructose syrup, such as high fructose corn syrup, to taste more like sugar. Also, if the high fructose syrup is high fructose corn syrup 42 (HFCS 42), adding the taste and flavor enhancing composition may cause the HFCS 42 to taste more like high fructose corn syrup 55 (H FCS 55).

The present disclosure is also directed to a method of making a taste and flavor enhancing composition, comprising: extracting steviol glycosides and other water soluble molecules from leaves of a Stevia rebaudiana plant, and separating the excess steviol glycosides than the amount and type of steviol glycosides required to contribute the taste and flavor modifying characteristics of the stevia extract, and adding to the extract prepared a disclosed taste modulator composition.

The present disclosure is also directed to a taste and flavor profile enhancing composition. The composition includes a disclosed glucosylated steviol glycoside composition and a disclosed taste modulator composition which can enhance the intensity of a taste and/or a flavor in a food or beverage product. In some aspects, the glucosylated steviol glycosides may include a plurality of glucose units. For example, the glucosylated steviol glycosides may include three, four, five, or more than five glucose units. As used herein, “a disclosed glucosylated steviol glycoside composition” refers to any glucosylated steviol composition comprise one or more steviol or steviol derivative as described herein throughout.

The present disclosure is also directed to a food or beverage product having an intense taste and flavor profile, wherein the food or beverage product includes a taste and flavor enhancing composition comprising a glucosylated steviol glycoside composition and a disclosed taste modulator composition. A wide range of food and beverage products, such as, but not limited to, carbonated soft drinks, fruit juices, dairy foods, dairy beverages, baked goods, cereal products, and table top sweeteners, may be made in accordance with the present disclosure. The taste and flavor profile of a food or beverage product including a taste and flavor enhancing composition, wherein the taste and flavor enhancing composition includes a disclosed glucosylated steviol glycoside composition and a disclosed taste modulator composition, may be more intense than a comparative taste and flavor profile of a comparative food or beverage product which does not include the taste and flavor enhancing composition. Moreover, the mouthfeel of a food or beverage product including the taste and flavor enhancing composition, wherein the taste and flavor enhancing composition includes a disclosed glucosylated steviol glycoside composition and a disclosed taste modulator composition, may be improved in relation to a mouthfeel of a comparative food or beverage product which does not include the taste and flavor enhancing composition.

The present disclosure is further directed to a method of increasing the taste and flavor intensity of a food or beverage product, including the step of adding a taste and flavor enhancing composition to the food or beverage product, wherein the taste and flavor enhancing composition includes a disclosed glucosylated steviol glycoside composition and a disclosed taste modulator composition. The present disclosure is also directed to a method of improving the organoleptic properties of a food or beverage product including a high fructose syrup, including the step of adding the taste and flavor enhancing composition to the food or beverage product. For example, adding the taste and flavor enhancing composition may cause the high fructose syrup, such as high fructose corn syrup, to taste more like sugar. Also, if the high fructose syrup is high fructose corn syrup 42 (HFCS 42), adding the taste and flavor enhancing composition may cause the HFCS 42 to taste more like high fructose corn syrup 55 (H FCS 55).

The present disclosure is further directed to a method of making a food or beverage product, including: adding a taste and flavor enhancing composition including a disclosed steviol glycoside composition, and adding an amount or a reduced amount of erythritol, wherein the amount or reduced amount of erythritol is less than the amount of erythritol in a comparative food or beverage composition which does not include the taste and flavor enhancing composition. The mouthfeel of the food or beverage product is similar to the mouthfeel of the comparative food or beverage product, even though the comparative food or beverage product contains a higher level of erythritol.

The present disclosure is also directed to a taste and flavor profile enhancing composition. The composition includes a disclosed glucosylated steviol glycoside composition, a disclosed monk fruit composition, and a disclosed taste modulator composition which can enhance the intensity of a taste and/or a flavor in a food or beverage product. In some aspects, the glucosylated steviol glycosides may include a plurality of glucose units. For example, the glucosylated steviol glycosides may include three, four, five, or more than five glucose units. As used herein, “a disclosed glucosylated steviol glycoside composition” refers to any glucosylated steviol composition comprise one or more steviol or steviol derivative as described herein throughout. As used herein, “a disclosed monk fruit composition” refers to any monk fruit juice, extract, composition, or mixture, including a juice, extract, composition, or mixture comprising mogroside V, as described herein throughout.

The present disclosure is further directed to a method of making a food or beverage product, including: adding a taste and flavor enhancing composition including a disclosed glucosylated steviol glycoside composition, a disclosed monk fruit composition, and a disclosed taste modulator composition, and adding a reduced amount of erythritol, wherein the reduced amount of erythritol is less than the amount of erythritol in a comparative food or beverage composition which does not include the taste and flavor enhancing composition. The mouthfeel of the food or beverage product is similar to the mouthfeel of the comparative food or beverage product, even though the comparative food or beverage product contains a higher level of erythritol.

### Products Comprising the Disclosed Compositions

In various aspects, the present disclosure, relates to products comprising a disclosed sweetening composition. In various aspect, the product can be a beverage, a food product, a nutraceutical, a concentrated sweetener composition, pharmaceutical, a dietary supplement, a dental hygienic composition, an edible gel composition, a cosmetic product, and a tabletop flavoring. In a further aspect, the present disclosure relates to a tabletop sweetener composition comprising a disclosed sweetening agent.

As used herein, “food product” or “food item” refers to fruits, vegetables, juices, meat products such as ham, bacon and sausage; egg products, fruit concentrates, gelatins and gelatin-like products such as jams, jellies, preserves, and the like; milk products such as ice cream, sour cream, yogurt, and sherbet; icings, syrups including molasses; corn, wheat, rye, soybean, oat, rice and barley products, cereal products, nut meats and nut products, cakes, cookies, confectionaries such as candies, gums, fruit flavored drops, and chocolates, chewing gum, mints, creams, icing, ice cream, pies and breads. “Food product” or “food item” also refers to condiments such as herbs, spices and seasonings, flavor enhancers, such as monosodium glutamate. “Food product” or “food item” further refers to also includes prepared packaged products, such as dietetic sweeteners, liquid sweeteners, tabletop flavorings, granulated flavor mixes which upon reconstitution with water provide non-carbonated drinks, instant pudding mixes, instant coffee and tea, coffee whiteners, malted milk mixes, pet foods, livestock feed, tobacco, and materials for baking applications, such as powdered baking mixes for the preparation of breads, cookies, cakes, pancakes, donuts and the like. “Food product” or “food item” also refers to diet or low-calorie food and beverages containing little or no sucrose.

As used herein, the term “gelling ingredient” refers to any material that can form a colloidal system within a liquid medium. Examples of suitable gelling ingredients can be, for example, gelatin, alginate, carageenan, gum, pectin, konjac, agar, food acid, rennet, starch, starch derivatives, and combinations thereof. It is well known to those in the art that the amount of gelling ingredient used in an edible gel mix or an edible gel composition can vary considerably depending on a number of factors such as, for example, the particular gelling ingredient used, the particular fluid base used, and the desired properties of the gel.

Gel mixes and gel compositions of the present disclosure can be prepared by any suitable method known in the art. In some aspects, edible gel mixes and edible gel compositions of the present disclosure can be prepared using other ingredients in addition to a disclosed sweetener composition and the gelling agent. Examples of other suitable ingredients can be, for example, a food acid, a salt of a food acid, a buffering system, a bulking agent, a sequestrant, a cross-linking agent, one or more flavors, one or more colors, and combinations thereof.

In various aspects, a disclosed beverage can be a carbonated beverage product and a non-carbonated beverage product. The disclosed beverage can also be, for example, a soft drink, a fountain beverage, a frozen beverage; a ready-to-drink beverage; a frozen and ready-to-drink beverage, coffee, tea, a dairy beverage, a powdered soft drink, a liquid concentrate, flavored water, enhanced water, fruit juice, a fruit juice flavored drink, a sport drink, and an energy drink. It is understood that the disclosed beverage products can include one or more beverage ingredients such as, for example, acidulants, fruit juices and/or vegetable juices, pulp, etc., flavorings, coloring, preservatives, vitamins, minerals, electrolytes, erythritol, tagatose, glycerine, and carbon dioxide.

In various aspects, disclosed beverages can have any of numerous different specific formulations or constitutions. The formulation of a beverage product of the present disclosure can vary to a certain extent, depending upon such factors as the product's intended market segment, its desired nutritional characteristics, flavor profile, and the like. For example, in certain aspects, it can generally be an option to add further ingredients to the formulation of a particular beverage product. For example, additional (i.e., more and/or other) sweeteners can be added (sucralose, for example), flavorings (such as cola or lemon-lime), electrolytes, vitamins, fruit juices or other fruit products, tastants, masking agents and the like, flavor enhancers, and/or carbonation typically may be added to any such formulations to vary the taste, mouthfeel, nutritional characteristics, etc. In some aspects, the disclosed beverage can be a cola beverage that contains water, a disclosed sweetener composition, an acidulant, and flavoring. Exemplary flavorings can be, for example, cola flavoring, citrus flavoring, and spice flavorings. In some aspects, carbonation in the form of carbon dioxide can be added for effervescence. In other aspects, preservatives can be added, depending upon the other ingredients, production technique, desired shelf life, etc. In certain aspects, caffeine can be added. In a further aspect, a disclosed beverage can be a cola-flavored carbonated beverage, characteristically containing carbonated water, sweetener, kola nut extract and/or other flavoring, caramel coloring, one or more acids, and optionally other ingredients.

In one aspect of the present disclosure, a disclosed tabletop sweetener composition is provided that includes a HP sweetener and a taste modulator composition. In one aspect of the present disclosure, the weight ratio on a dry basis of the HP sweetener to the taste modulator composition is from about 0.0010:1 to about 1000:1. In another aspect of the present disclosure, the weight ratio on a dry basis of the HP sweetener to the taste modulator composition is from about 0.01:1 to about 286:1. In yet another aspect of the present disclosure, the weight ratio on a dry basis of the HP sweetener to the taste modulator composition is from about 1.8:1 to about 115:1. In a further aspect, a disclosed product is a tabletop sweetener comprising a disclosed sweetener composition. The tabletop composition optionally can further include at least one bulking agent, additive, anti-caking agent, functional ingredient and combinations thereof. The tabletop sweetener composition can be present in the form of a solid or a liquid. The liquid tabletop sweetener can comprise water and/or, other liquid carrier, and optionally additives, such, as for example polyols (e.g. erythritol, sorbitol, propylene glycol or glycerol), acids (e.g. citric acid), antimicrobial agents (e.g. benzoic acid or a salt thereof).

In another aspect of the present disclosure, a disclosed tabletop sweetener composition is provided that includes a bulking material, a HP sweetener and a taste modulator composition. In one aspect of the present disclosure, the weight ratio on a dry basis of the bulking material to the HP sweetener to the taste modulator composition is from about 0.0010:0.1:1 to about 1000:100,000:1. In another aspect of the present disclosure, the weight ratio on a dry basis of the bulking material to the HP sweetener to the taste modulator composition is from about 225:1.80:1 to about 14,370:115:1. In still another aspect, the sweetener may include optional ingredients such as for example, characterizing flavors and colors. Alternatively, optional ingredients may be added to the taste modulator composition. It is also possible that optional ingredients may be added to both the sweetener and the taste modulator composition. Such optional ingredients generally are known to those of skill in the art and may include, for instance, coloring agents, carriers, flavor compounds and the like. For instance, the taste modulator composition may include a strawberry flavor compound to provide a sweetener composition capable of delivering not only a sweet flavor but also a strawberry flavor. This could then be incorporated into a strawberry yogurt product to increase the perception of strawberry flavor compared to a yogurt product without the taste modulator composition. Alternatively, a disclosed tabletop sweetener composition may be colored to a golden brown color to simulate the appearance of raw sugar. Other optional ingredients may include certain carriers and inactive ingredients. These carriers and inactive ingredients may merely facilitate processing of the sweetener. Additionally, a flow agent or anti-caking agent such as tricalcium phosphate may be added to improve flowability of a tabletop sweetener.

A disclosed tabletop sweetener composition may take many forms including, but not limited to, a crystal, a powder, a tablet, a cube, a glaze or coating, a granulated product, or combinations thereof.

In some cases, a disclosed tabletop sweetener composition may be provided in the form of a crystal that has an appearance comparable to that of sucrose crystals, e.g., to improve end user acceptance of the sweetener compositions. It may also be desirable to provide the sweetener in the form of a crystal that has similar solubility profile to sucrose, which becomes apparent, e.g., when the sweetener is mixed into an unsweetened beverage.

In some circumstances, the disclosed tabletop sweetener composition is not formulated to mimic the appearance or solubility characteristics of sucrose, is may be formulated to minimize volume, maximize solubility, maximize stability, or otherwise improve product handling and distribution.

One form of a disclosed tabletop sweetener composition may be an admixture. The disclosed tabletop sweetener composition may also be provided in the form of coated granules in which one or more first component of the sweetener composition is coated over one or more second component of the sweetener composition. For example, the taste modulator composition may be coated onto granules, crystals, or other forms of a HP sweetener, such that taste buds are first exposed to the taste modulator composition, and then to the HP sweetener. In this manner, the taste buds are modified by the taste modulator composition in preparation for exposure to the HP sweetener. In another example, the HP sweetener may be coated onto granules, crystals, or other forms of the taste modulator composition, such that taste buds are first exposed to the HP sweetener, followed by exposure to the taste modulator composition, which alters the perceived sweetness of the HP sweetener. This arrangement allows the taste modulator composition to potentially mask a bitter aftertaste associated with a HP sweetener while minimally affecting its initial perception of sweetness. In yet another example, the HP sweetener and taste modulator composition may be coated onto granules, crystals, or other forms of a bulking material, such that taste buds are first exposed to the HP sweetener and taste modulator composition, followed by exposure to the bulking material.

The disclosed tabletop sweetener composition may further include one or more bulking materials. In one aspect of the present disclosure, the bulking material may add bulk to the sweetener thereby making a single serving of the present compositions more similar to that of sucrose. End users of a sweetener may also find it easier to control the amount of sweetener added to a food or beverage, particularly when the serving size is similar to a known sweetener. Bulking materials may also contribute to body, viscosity, and other aspects of mouth-feel in liquids; volume, cell structure, crumb structure, and humectancy in baked goods; control over the freezing and melting points of foods and beverages; and overall visual and textural impressions of foods and beverages that include the present sweetener. In a further aspect, the bulking material itself may contribute to an increased sweet quality of the HP sweetener. In another aspect, the bulking material is low to non-caloric and may provide less than about 0.2 calories per gram of bulking agent.

In still another aspect of the present disclosure, the bulking material has a uniform crystalline structure, i.e. narrow particle size distribution. The uniform crystalline structure may provide for greater control over the ratio of bulking material to HP sweetener to taste modulator composition. In one aspect of the present disclosure, the bulking material has a size of from about 0.125 mm to about 1.0 mm. In another aspect of the present disclosure, the bulking material has a size of from about 0.21 mm to about 0.71 mm. In still another aspect of the present disclosure, the bulking material has a size of from about 0.25 mm to about 0.60 mm.

In yet another aspect of the present disclosure, the bulking agent has a solubility profile that is slower than either the HP sweetener or taste modulator composition. Thus, if the HP sweetener and taste modulator composition were to be deposited onto a bulking agent to form a tabletop sweetener product, the tabletop sweetener product may actually perform more like sugar when introduced into a beverage, particularly a cold beverage, where the granules do not immediately dissolve.

Exemplary bulking materials may be selected from the group consisting of maltodextrin, corn syrup solids, sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, trehalose, isomaltulose, arabinogalactan, gum Arabic, gum tragacanth, guar gum and hydrolyzed guar gum, and mixtures thereof. It may also be possible to utilize certain starches and modified starches.

In one aspect of the present disclosure, the bulking material is erythritol. In another aspect, the bulking material is glycerol or propylene glycol. These particular bulking materials are available in a liquid form, which may provide for a liquid tabletop sweetener preparation.

The present disclosure further includes methods of preparing the disclosed tabletop sweetener composition. In one aspect, the disclosed tabletop sweetener composition of the present disclosure is prepared by dissolving a HP sweetener and a taste modulator composition in water. The HP sweetener and taste modulator composition may either be dissolved individually to form two aqueous solutions or in combination to form a single aqueous solution containing both the HP sweetener and taste modulator composition. In the event that the HP sweetener and taste modulator composition are dissolved in combination, the HP sweetener and taste modulator composition may be added in any order, including simultaneously. In the event the HP sweetener and taste modulator composition are dissolved individually, they may be later combined into a single, aqueous mixture. In one aspect, the temperature of the water is at room temperature. In another aspect, the temperature of the water is heated, such as for example to from about 10 to about 70° C. In still another aspect, the temperature of the water used for the HP sweetener is heated while the temperature of the water used for the taste modulator composition is at room temperature. Where the taste modulator composition includes more than one component, such as for example, a plurality of congruent flavor volatiles and at least one non-congruent flavor volatile, the components may be delivered in a single fraction or in more than one fraction. For example, the components may be added using a powder fraction containing a blend of dry powdered components and a liquid fraction containing and blend of the remaining components that have been dissolved in an appropriate carrier solution such as water and ethanol. The sweetener can then be processed in a number of ways, such as for example, spray drying, to reduce the moisture level of the sweetener.

In another aspect, is provided a method of preparing a disclosed tabletop sweetener composition. Generally, a HP sweetener and a taste modulator composition are deposited onto a bulking material having a size distribution of from about 0.125 mm to about 1.0 mm. The HP sweetener and taste modulator composition can be deposited in any order, including simultaneously. Methods to deposit the HP sweetener and taste modulator composition will be generally known to one of skill in the art. For example, the bulking material can be placed in a coating vessel (positioned on the right side of the diagram) and air is blown through the vessel (from the bottom of the vessel through the top) in order to cause the bulking material to move about randomly inside of the vessel (i.e., the particles are fluidized). Next, a solution comprising HP sweetener in water is introduced into the vessel and is allowed to deposit on the surface of the bulking material. Heated air is blown through the coating vessel in order to dry the HP sweetener onto the bulking material. After coating the bulking material with HP sweetener, the taste modulator composition is introduced into the coating vessel as a water-based solution. Similar to the HP sweetener, the taste modulator composition deposits on the surface of the bulking material and is dried by blowing air through the coating vessel. In a particular aspect of the present disclosure, the air that is blown through the coating vessel is not heated. This may reduce thermal degradation of the taste modulator composition. The resulting tabletop sweetener composition includes a bulking material with HP sweetener and a taste modulator composition deposited on its surface. The resulting tabletop sweetener may also be prepared by first introducing the taste modulator composition into the vessel and then introducing the HP sweetener solution into the vessel. Alternatively, the HP sweetener solution and liquid taste modulator composition may be added simultaneously into the vessel. In one aspect, the HP sweetener is rebaudioside A and the bulking material is erythritol. In another aspect, the size distribution of the bulking material is such that the tabletop sweetener has a desired taste and serving-to-serving consistency. In particular, the size distribution of the bulking material is selected to provide tabletop sweetener particles that have the desired ratio of HP sweetener to bulking material and HP sweetener to taste modulator composition. Furthermore, the tabletop sweetener particle size is similar to sugar.

In still another aspect, an HP sweetener is dissolved in room temperature water. A taste modulator composition, also at room temperature, is blended into the HP sweetener-water mixture. A bulking material is added to an agglomeration unit where it is suspended by heated air. While suspended, the mixture of HP sweetener, taste modulator composition and water is sprayed into the agglomeration unit in such a way as to allow the components to deposit onto the bulking material. By controlling the temperature in the agglomeration unit the water is removed and the moisture content of tabletop sweetener is comparable to the starting moisture of the bulking material.

In yet another aspect, a HP sweetener is dissolved in heated water. In one aspect, the heated water increases the solubility of the HP sweetener and therefore less water is necessary to fully dissolve the HP sweetener. A bulking material is added to an agglomeration unit where it is suspended by heated air. While suspended, the mixture of HP sweetener and water is sprayed into the agglomeration unit in such a way as to allow the components to deposit onto the bulking material. The HP sweetener is then dried onto the bulking material using heated air. In one aspect, the air is heated to from about 20 to about 130° C. In another aspect, the air is heated to from about 60 to about 70° C. The bulking material deposited with HP sweetener continues to be suspended by air only the temperature of the air is reduced. In one aspect the temperature of the air is reduced to ambient temperature. A mixture of a taste modulator composition and room temperature water is then introduced into the agglomeration unit in such a way as to allow the components to deposit onto the bulking material and HP sweetener. By controlling the temperature in the agglomeration unit the water is removed to obtain final moisture content of the tabletop sweetener comparable to that of the starting moisture of the bulking material. In one aspect, the air temperature is from about 20 to about 130° C. In an aspect, the method produces a tabletop sweetener in which the ratio on a dry weight basis of bulking material to HP sweetener to taste modulator composition is from about 225:1.80:1 to about 14,370:115:1. In a further aspect, the bulking material is erythritol and the HP sweetener is rebaudioside A.

Also provided in the present disclosure are food and beverage products containing either the disclosed tabletop sweetener composition. Exemplary foods and beverages include baked goods, chocolate, candy and confections, chewing gum, ice cream, yogurt, breakfast cereal, oatmeal, pudding, fruit preserves and preparations, breakfast bars, protein bars, granola bars, cereal coatings, syrups, marinades, ketchup, salad dressings, baby food, pet food, animal feed, soft drinks, fruit juices, coffee, tea, sport and energy drinks, and other foods and beverages. A particular class of beverages for which the present compositions and methods are useful is diet soft drinks (or sodas), such as colas, citrus and fruit flavored beverages, and the like. Additionally, pharmaceutical and over the counter drug products may contain either the disclosed tabletop sweetener composition.

### Sensory Testing Methodology

In various aspects, the present disclosure pertains to methods of testing the disclosed sweetener compositions, e.g., a sensory methodology or method for sweetener evaluation. In a particular aspect, the sensory methodology used is known as a “Quantitative Descriptive Analysis®” as has been previously described (see, for example, “Stone, H., Sidel, J., Oliver, S., Woolsey, A., and Singleton, R. C., (1974). Sensory evaluation by quantitative descriptive analysis. Food Technol. 28(11), 24, 26, 28, 29, 32, 34.” and “Kemp, S. E., Hollowood T., Hort J. Sensory Evaluation: A Practical Handbook (Wiley-Blackwell 2009)” (in particular pages 111 and 163 of “Sensory Evaluation: A Practical Handbook” for discussion of Quantitative Descriptive Analysis methodology, both references being incorporated herein by reference in their entireties as previously noted).

Briefly, QDA® was developed at the Stanford Research Institute by Stone and Sidel (Stone et al. 1974) to provide descriptive data that could be analyzed statistically, in contrast to other methods. It can produce a full qualitative and quantitative sensory description. Assessors (8-15), selected for their ability to describe and discriminate products in the category to be studied, agree on a list of qualitative attributes and then work individually to rate the attributes on a line scale with indented anchors. Assessors receive limited training and the primary aim for assessors is to be consistent within themselves rather than with the rest of the panel. It is, therefore, a relative assessment method. The panel leader facilitates discussions rather than leads them. Assessments are made in replicates of 2-6 repeat evaluations, data are translated into mean scores and statistically analyzed using ANOVA, individual assessor performance is monitored and compared to that of the panel, and results are presented graphically in spider plots. The attributes are said to be closer to the language a consumer might use. QDA® is a versatile technique that can be used across a range of applications.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and sub-combinations are of utility and may be employed without reference to other features and sub-combinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, ingredient concentrations are weight/volume (e.g., mg/L) or molar/millimolar, temperature is in ° C. or is at ambient temperature, and pressure is at or near atmospheric.

It should be noted that certain tables referred to herein below follow this section and before the claims in full-page format in landscape orientation and rotated 90° counterclockwise to the text preceding and following these tables.

### Example 1. Embodiments of Compositions of the Present Disclosure

Table 3 below shows a compositional breakdown of embodiments of sweetening compositions according to the present disclosure.

Steviose® Omega 3 (also referred to herein throughout the disclosure as “Steviose® Omega”) B/N: 2106040 contains Total Steviol Glycosides, Reb A and Reb C are higher than the control (RB115) about 6.00, 8,16 and 3.50% respectively. Whereas other parameters are slightly different from the control. This is also affects sweetness level too. A comparison was also done with a Steviose® Omega 3 spray, where it was noted that there was a slight difference in the Steviose® Omega 3 spray and samples B/N: 1909120 and RB 115, in particular has intensity of sweetness and sweetness linger higher than standard but lower sweetness appearance over time.

TABLE 3
Embodiments of Compositions of the Present Disclosure

| | | | | | Results | |
|---|---|---|---|---|---|---|
| ITEM No. | PARAMETER | SPECIFICATION | | UNIT | RB115 (Control) | B/N: 2106040 |
| 1 | Appearance | Yellowish to White | | — | Yellowish | Yellowish |
| 3 | Solubility (50% Ethanol) | Freely Soluble | | — | Freely Soluble | Freely Soluble |
| 3 | Moisture Content | 6.0 | max | % | 0.73 | 0.79 |
| 4 | Residual Ethanol | 5,000 | max | ppm | 1,036 | <50 |
| 5 | Residual Methanol | 200 | max | ppm | <50 | <50 |

| | | | | | |
|---|---|---|---|---|---|
| 6 | pH (1%) | 4.5-7.0 | — | 4.59 | 5.23 |
| 7 | Total Steviol Glycosides | — | % w/w | 76.53 | 82.53 |
| 8 | Rebandioside D | — | % w/w | 1.47 | 1.82 |
| 9 | Rebaudioside A | — | % w/w | 35.82 | 43.98 |
| 10 | Stevioside | — | % w/w | 16.77 | 18.67 |
| 11 | Rebaudioside F | — | % w/w | 1.43 | 0.81 |
| 12 | Rebaudioside C | — | % w/w | 9.98 | 6.48 |
| 13 | Dulcoside A | — | % w/w | 0.22 | 0.48 |
| 14 | Rubusoside | — | % w/w | 0.98 | 0.14 |
| 15 | Rebaudioside B | — | % w/w | 6.71 | 6.60 |
| 16 | Steviolbioside | — | % w/w | 3.15 | 3.55 |

### Example 2. Materials and Methods—Sweet Taste

Representative formulations within the scope of the disclosed formulations were prepared and subjected to sensory testing by Quantitative Descriptive Analysis® methods described above, herein, and further at least in references incorporated herein by reference.

Materials used in these studies were as follows: GSG was either Almendra Steviarore™ 2050 (GSG-2050) and Almendra Steviarome™ 5000 (GSG-5000), each was obtained from Almendra (Thailand) Ltd., Bangkok, Thailand; Steviose Omega 3 (also referred to herein throughout this example and disclosure as “Steviose Omega”, formed from a raw material comprising REBA in an amount of about 50-55%) and Steviose Omega V (formed from a raw material comprising REBA in an amount of about 70-75%) and which can be prepared from raw Almendra Steviose™ TSG 095 (total steviol glycosides≥95%) and Almendra Steviose™ 100 (total steviol glycosides 100%), respectively (Almendra (Thailand) Ltd., Bangkok, Thailand). Briefly, Coca-Cola® (regular formulation, 10% sugar) was diluted with water by either 50% (50:50 dilution) or 30% (70:30 dilution) and the sweetener compositions added to the diluted beverage.

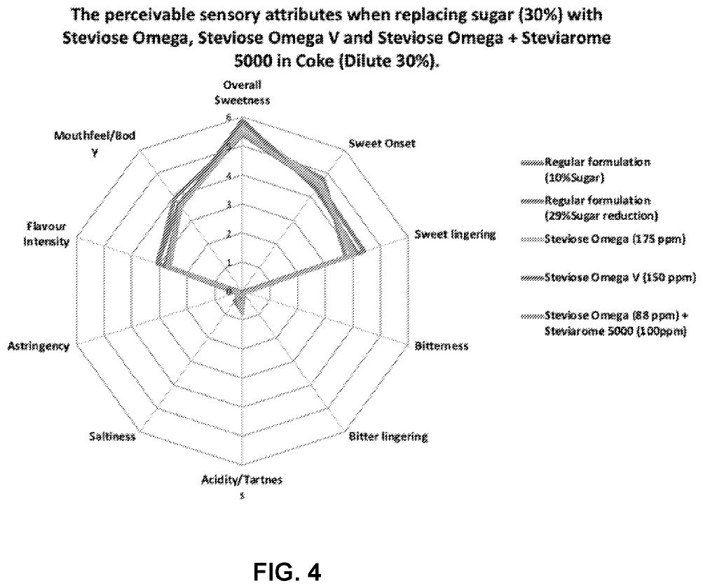

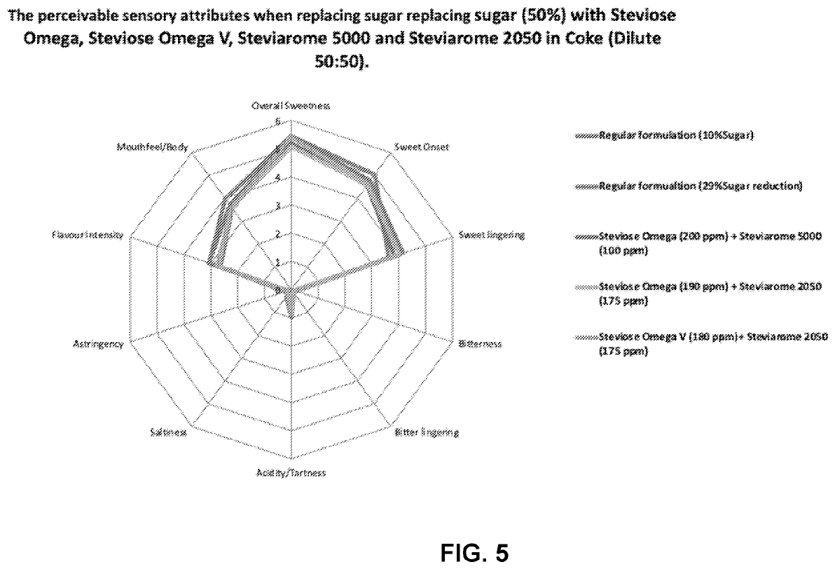

FIGS. 4 and 5 are spider plots showing perceivable sensory attributes when replacing sugar (30%) with aspects of the present disclosure and plots showing perceivable sensory attributes when replacing sugar (50%) with aspects of the present disclosure, respectively.

Tables 4 and 5 below show compositional breakdowns of samples of beverage compositions used in the study according to the present example. Additionally, it is noted that control samples for the study exhibited a pH of 2.587 and a Brix degree of 10.5 (Brix being the percent by weight of sugar solids in a pure sucrose solution). The 70:30 dilute samples of table 4 (and FIG. 4) exhibited a dilute pH after dilution of 2.701 that was adjusted to a final pH of 2.571 with the addition of phosphoric acid (0.0146 g), and a final Brix degree of 7.0. The 50:50 dilute samples of table 5 (and FIG. 5) exhibited a dilute pH after dilution of 2.723 that was adjusted to a final pH of 2.571 with the addition of phosphoric acid (0.0146 g), and a final Brix degree of 5.0.

TABLE 4
Embodiments of Beverage Compositions of the Present Disclosure

| Net Weight (g) | | 100 | Control | | | Steviose Omega | | |
|---|---|---|---|---|---|---|---|---|
| Ingredient | | Supplier | Target (%) | Target (g) | Actual (g.) | Target (%) | Target (g.) | Actual (g.) |
| 1 | Coke Original (10% Sugar) | | 100.00 | 100.00 | 100.00 | 69.97 | 70.00 | 69.97 |
| 2 | Water | | | | | 29.99 | 30.00 | 29.99 |
| 3 | Phosphoric acid | | | | | 0.0146 | 0.0145 | 0.0146 |
| 4 | Cola Flavor | | | | | 0.0170 | 0.0170 | 0.0170 |
| 5 | Steviose Omega | Almendra | | | | 0.0175 | 0.0175 | 0.0175 |
| 6 | Steviose Omega V | Almendra | | | | | | |
| 7 | Steviarome 5000 | Almendra | | | | | | |
| | Total (Base) | | 100.00 | 100.00 | 100.00 | 100.00 | 100.05 | 100.00 |
| | | | | | | Steviose Omega + | | |
| | | | Steviose Omega V | | | Steviarome 5000 | | |
| Net Weight (g) | | 100 | Target | Target | Actual | Target | Target | Actual |
| Ingredient | | Supplier | (%) | (g.) | (g.) | (%) | (g.) | (g.) |
| 1 | Coke Original (10% Sugar) | | 69.97 | 70.00 | 69.97 | 69.96 | 70.00 | 69.96 |
| 2 | Water | | 29.99 | 30.00 | 29.99 | 29.98 | 50.00 | 29.98 |
| 3 | Phosphoric acid | | 0.0146 | 0.0146 | 0.0146 | 0.0146 | 0.0146 | 0.0146 |
| 4 | Cola Flavor | | 0.0170 | 0.0170 | 0.0170 | 0.0170 | 0.0170 | 0.0170 |
| 5 | Steviose Omega | Almendra | | | | 0.0088 | 0.0088 | 0.0088 |
| 6 | Steviose Omega V | Almendra | 0.0150 | 0.0150 | 0.0150 | | | |
| 7 | Steviarome 5000 | Almendra | | | | 0.0100 | 0.0100 | 0.0100 |
| | Total (Base) | | 100.00 | 100.05 | 100.00 | 100.00 | 100.05 | 100.00 |

TABLE 5
Embodiments of Beverage Compositions of the Present Disclosure

| | Net Weight (g) | 100 | Control | | | Steviose Omega + Steviarome 5000 | | |
|---|---|---|---|---|---|---|---|---|
| Ingredient | | Supplier | Target (%) | Target (g) | Actual (g.) | Target (%) | Target (g.) | Actual (g.) |
| 1 | Coke Original (10% Sugar) | | 100.0000 | 100.00 | 100.00 | 49.95 | 50.00 | 49.96 |
| 2 | Water | | | | | 49.96 | 50.00 | 49.96 |
| 3 | Phosphoric acid | | | | | 0.0150 | 0.0150 | 0.0150 |
| 4 | Cola Flavor | | | | | 0.0280 | 0.0280 | 0.0280 |
| 5 | Steviose Omega | Almendra | | | | 0.0200 | 0.0200 | 0.0200 |
| 6 | Steviose Omega V | Almendra | | | | | | |
| 7 | Steviorome 5000 | Almendra | | | | 0.0100 | 0.0100 | 0.0100 |
| 8 | Steviorome 2050 | Almendra | | | | | | |
| | Total (Base) | | 100.00 | 100.00 | 100.00 | 100.00 | 100.07 | 100.00 |

| | | | Steviose Omega + | | | Steviose Omega V + | | |
|---|---|---|---|---|---|---|---|---|
| | | | Steviarome 2050 | | | Steviarome 2050 | | |
| | Net Weight (g) | 100 | Target | Target | Actual | Target | Target | Actual |
| | Ingredient | Supplier | (%) | (g.) | (g.) | (%) | (g.) | (g.) |
| 1 | Coke Original (10% Sugar) | | 49.96 | 50.00 | 49.96 | 49.96 | 50.00 | 49.96 |
| 2 | Water | | 49.96 | 50.00 | 49.96 | 49.96 | 50.00 | 49.96 |
| 3 | Phosphoric acid | | 0.0150 | 0.0150 | 0.0150 | 0.0150 | 0.0150 | 0.0150 |
| 4 | Cola Flavor | | 0.0280 | 0.0280 | 0.0280 | 0.0280 | 0.0280 | 0.0280 |
| 5 | Steviose Omega | Almendra | 0.0190 | 0.190 | 0.0190 | | | |
| 6 | Steviose Omega V | Almendra | | | | 0.0180 | 0.0180 | 0.0180 |
| 7 | Steviorome 5000 | Almendra | | | | | | |
| 8 | Steviorome 2050 | Almendra | 0.0175 | | 0.0175 | 0.0175 | 0.0175 | 0.0175 |
| | Total (Base) | | 100.00 | 100.08 | 100.00 | 100.00 | 100.08 | 100.00 |

Perceivable sensory attributes when replacing sugar (30%) with Steviose® Omega, Steviose® Omega V, and Steviarome® 5000 in a 70:30 dilution of coke (coke:water; Coca-Cola® regular and reduced-sugar formulations from the Coca-Cola® company). As can be seen in FIG. 4, replacing sugar (30%) with Steviose® Omega, Steviose® Omega V, and Steviarome® 5000 in a 70:30 dilution of coke provides no statistically-significant differences (p>0.05) between the perceivable sensory attributes of the regular (10% sugar), reduced-sugar (29% reduction), and Steviose® Omega, Steviose® Omega V, and Steviarome® 5000 additions. It is concluded that a 70:30 dilution of Coca-Cola® in water with Steviose® Omega, Steviose® Omega V, and Steviarome® 5000 added has the same taste profile as the regular formulation (10%) sugar and reduced-sugar formulations (29% reduction) of Coca-Cola®. Embodiments of sweeteners employing Steviose® Omega and Omega V and mixtures of Steviose® Omega (3) and Steviarome® (5000) are shown.

Perceivable sensory attributes when replacing sugar (50%) with Steviose® Omega, Steviose® Omega V, Steviarome® 5000 and Steviarome® 2050 in a 50:50 dilution of coke (coke:water; Coca-Cola® regular and reduced-sugar formulations from the Coca-Cola® company). As can be seen in FIG. 5, replacing sugar (50%) with Steviose® Omega, Steviose® Omega V, Steviarome® 5000 and Steviarome® 2050 in a 50:50 dilution of coke provides no statistically-significant differences (p>0.05) between the perceivable sensory attributes of the regular (10% sugar), reduced-sugar (29% reduction), and Steviose® Omega, Steviose® Omega V, Steviarome® 5000 and Steviarome® 2050 additions. It is concluded that a 50:50 dilution of Coca-Cola® in water with Steviose® Omega, Steviose® Omega V, Steviarome® 5000 and Steviarome® 2050 added has the same taste profile as the regular formulation (10%) sugar and reduced-sugar formulations (29% reduction) of Coca-Cola®. Embodiments of sweeteners employing mixtures of Steviose® Omega and Omega V and Steviarome® (5000 and 2050) are shown.

It should be emphasized that the above-described aspects, including the tables herein below, of the present disclosure are merely possible examples of implementations set forth for a clear understanding of the principles of the disclosure. Many variations and modifications may be made to the above-described aspect(s) without departing substantially from the spirit and principles of the disclosure. All such modifications and variations are intended to be included herein within the scope of this disclosure and protected by the following claims.

1-112. (canceled)

113. A beverage composition comprising a sweetener composition, the sweetener composition comprising:
total steviol glycosides in an amount of about 76% to about 82% w/w; rebaudioside D in an amount of about 1% w/w to about 2% w/w;
rebaudioside A in an amount of about 35% to about 44% w/w;
stevioside in an amount of about 16% to about 19% w/w;
rebaudioside F in an amount of about 0.75% to about 1.5% w/w;
rebaudioside C in an amount of about 6% to about 10% w/w;
dulcoside A in an amount of about 0.2% to about 0.5% w/w;
rubusoside in an amount of about 0.1% to about 1% w/w;
rebaudioside B in an amount of about 6.5% to about 7% w/w; and
steviolbioside in an amount of about 3% to about 3.6% w/w.

114. The beverage composition of claim 113, wherein the sweetener composition further comprises trace amounts of glucose.

115. The beverage composition of claim 113, wherein the sweetener composition does not contain glucose.

116. The beverage composition of claim 113, wherein the beverage composition further comprises a cola-flavored or lemon-lime flavored beverage.

117. The beverage composition of claim 116, wherein the beverage composition further comprises a carbonated cola-flavored or carbonated lemon-lime flavored beverage.

118. The beverage composition of claim 113, wherein the beverage composition further comprises a Coca-Cola® beverage.

119. The beverage composition of claim 113, wherein the beverage composition further comprises a Sprite® beverage.

120. A beverage composition comprising a sweetener composition, the sweetener composition comprising:
total steviol glycosides in an amount of about 76% w/w; rebaudioside D in an amount of about 1.5% w/w;
rebaudioside A in an amount of about 36% w/w; stevioside in an amount of about 17% w/w;
rebaudioside F in an amount of about 1.4% w/w; rebaudioside C in an amount of about 10% to about 10% w/w;
dulcoside A in an amount of about 0.2% w/w;
rubusoside in an amount of about 1% w/w;
rebaudioside B in an amount of about 7% w/w; and
steviolbioside in an amount of about 3% w/w.

121. The beverage composition of claim 120, wherein the sweetener composition further comprises trace amounts of glucose.

122. The beverage composition of claim 120, wherein the sweetener composition does not contain glucose.

123. The beverage composition of claim 120, wherein the beverage composition further comprises a cola-flavored or lemon-lime flavored beverage.

124. The beverage composition of claim 120, wherein the beverage composition further comprises a carbonated cola-flavored or carbonated lemon-lime flavored beverage.

125. The beverage composition of claim 120, wherein the beverage composition further comprises a Coca-Cola® beverage.

126. The beverage composition of any of claim 120, wherein the beverage composition further comprises a Sprite® beverage.

127. A beverage composition comprising a sweetener composition, the sweetener composition comprising:
total steviol glycosides in an amount of about 82% w/w; rebaudioside D in an amount of about 2% w/w;
rebaudioside A in an amount of about 44% w/w; stevioside in an amount of about 19% w/w;
rebaudioside F in an amount of about 0.8% w/w; rebaudioside C in an amount of about 6.5% w/w;
dulcoside A in an amount of about 0.5% w/w; rubusoside in an amount of about 0.1% w/w;
rebaudioside B in an amount of about 6.5% w/w; and
steviolbioside in an amount of about 3.5% w/w.

128. The beverage composition of claim 127, wherein the sweetener composition further comprises trace amounts of glucose.

129. The beverage composition of claim 127, wherein the sweetener composition does not contain glucose.

130. The beverage composition of claim 127, wherein the beverage composition further comprises a cola-flavored or lemon-lime flavored beverage.

131. The beverage composition of claim 127, wherein the beverage composition further comprises a carbonated cola-flavored or carbonated lemon-lime flavored beverage.

132. The beverage composition of claim 127, wherein the beverage composition further comprises a Coca-Cola® beverage or a Sprite® beverage.

133-137. (canceled)
